(19) United States
(12) Patent Application Publication
(10) Pub. No.: US 2023/0164534 A1
(43) Pub. Date: May 25, 2023

(54) Service-Based User Plane Entity for a Wireless Communication Network

(71) Applicant: Telefonaktiebolaget LM Ericsson (publ), Stockholm (SE)

(72) Inventors: Miguel Angel Muñoz De La Torre Alonso, Madrid (ES); Aldo Bolle, Västra Frölunda (SE); Miguel Angel Puente Pestaña, Madrid (ES)

(21) Appl. No.: 17/916,835

(22) PCT Filed: May 27, 2020
(86) PCT No.: PCT/EP2020/064698

§ 371 Date: Oct. 4, 2022

(30) Foreign Application Priority Data
Apr. 8, 2020 (EP) 20382286.1

(51) Int. Cl. H04W 8/00

(52) U.S. Cl. CPC H04W 8/005

(57) ABSTRACT

The invention relates to various methods and apparatuses for implementing service-based user plane entity in a wireless communication network. One method relates in particular to method for operating a user plane entity (21) in a wireless communication network, the wireless communication network comprising the user plane entity (21), a plurality of session control entities (22) and a network repository entity (23). The plurality of session control entities (22) can be configured to handle at least one data packet session in the wireless communication network, the user plane entity (21) can be configured to handle a user plane of the at least one data packet session, and the network repository entity (23) can be configured to register the plurality of session control entities (22) and the user plane entity (21). The method comprises a step S2-3 of transmitting to the network repository entity (23) a discovery message comprising: an association request indication, for indicating that the user plane entity (21) can be associated to a session control entity (22), and filtering criteria for filtering the plurality of session control entities (22). The method further comprises a step S2-4 of receiving from the network repository entity (23) a response message, in response to the discovery message, comprising: a list of filtered session control entities (22), filtered based on the filtering criteria. The method also comprises a step S2-5 of transmitting to a first filtered session control entity (22), of the filtered session control entities (22), an association request message comprising: an identifier of the user plane entity (21).

### TECHNICAL FIELD

The present invention relates to methods for enabling and operating a service-based user plane entity for a wireless communication network and to corresponding network entities.

### BACKGROUND

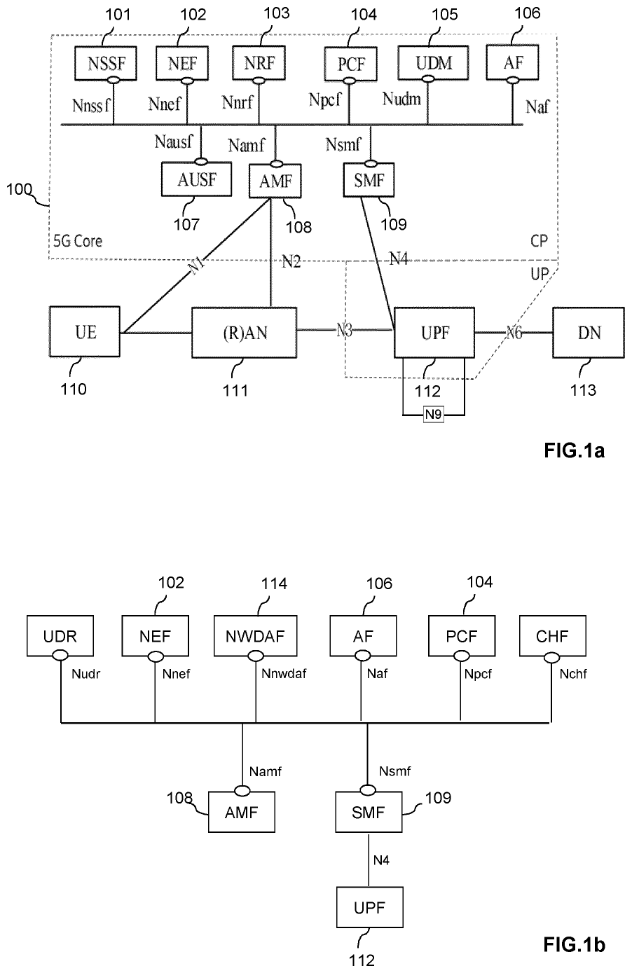

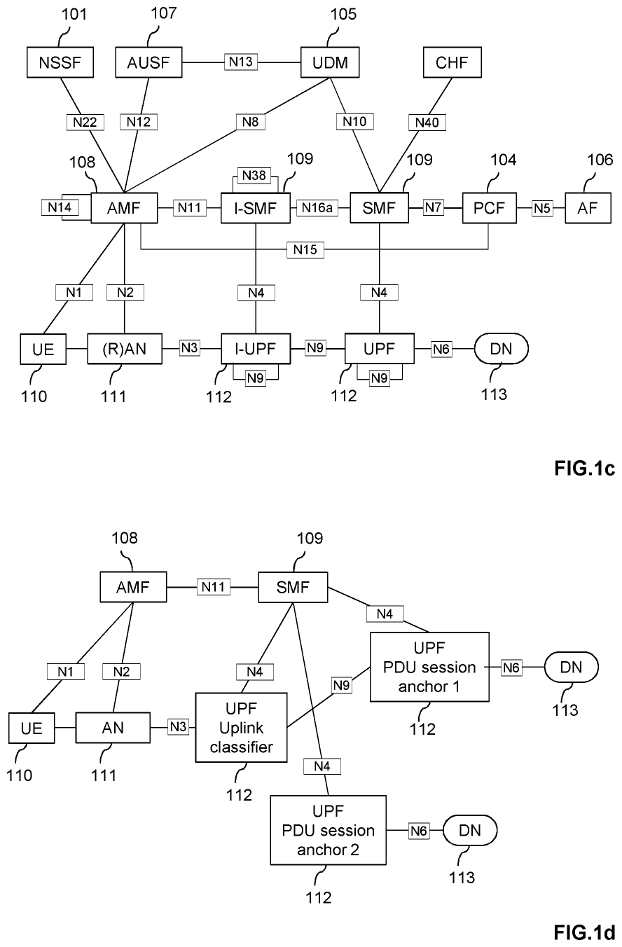

FIG. 1a shows a 5G New Radio, NR, architecture with service based interfaces. FIG. 1b shows the 5GC architecture for policy, charging and analytics. Service Based Interfaces are represented in the format Nxyz, such as Nsmf, and point to point interfaces in the format Nx, such as N4.

The 5G core network 100 part comprises a Network Slice Selection Function, NSSF, 101, a Network Exposure Function, NEF, 102, a Network Repository Function, NRF, 103, a Policy Control Function, PCF, 104, a Unified Data Management, UDM, 106, an Application Function, AF, 106, an Authentication Server Function, AUSF, 107, an Access and Mobility Management Function, AMF, 108, and a Session Management Function, SMF, 109. Having service based interfaces in the 5G Core Control Plane, CP, implies that the Network Functions, NFs, in the 5G Core CP provide services that are consumed by other NFs in the 5G Core CP.

A User Equipment, UE, 110, is connected to the Radio Access Network, RAN, 111, wherein a User Plane Function, UPF, 112 is provided to connect the UE 110 to a Data Network, DN, 113.

The roles of these entities and the interfaces between them are defined, for instance, in the 3GPP TS 23.501 and the procedures are described, for instance, in 3GPP TS 23.502.

Relevant 5G System Architecture network aspects and functions for this invention are the following:
Network Exposure Function, NEF, 102 generally is the entry point for Application Service Providers, ASPs, to the Mobile Network Operator Network a.k.a. Connectivity Service Provider, CSP. NEF 102 generally exposes the Connectivity Service Provider Mobile Network capabilities to the ASPs and translates between information as known by the external Application Functions, AFs, and information as known by the Mobile Network Function/s;
Policy Control Function, PCF, 104, generally supports unified policy framework to govern the network behaviour. In particular, PCF 104 generally provides Policy and Charging Control, PCC, rules to the Policy and Charging Enforcement Function, PCEF, that is, SMF 109/UPF 112 that enforces policy and charging decisions according to provisioned PCC rules;
Unified Data Management/Repository, UDM, 105, and UDR, not illustrated. The UDM generally manages network user data in a single, centralized element and can be paired with the UDR, which generally stores user data such as customer profile information, customer authentication information, encryption keys, etc;
Application Function, AF, 106, generally interacts with the 3GPP Core Network so as to provide information that will allow network operator to manage application's traffic in a certain way;
Session Management Function, SMF, 109 is generally responsible for Session establishment, modification and release, including selection and control of the UPF 112 entities. In the known art, SMF 109 interacts with the UPF 112 over N4 Reference point using Packet Flow Central Protocol, PFCP, procedures. Moreover, SMF 109 generally receives PCC rules from PCF 104 and configures the UPF 112 accordingly;
User Plane Function, UPF, 112, generally supports handling of user plane traffic based on the rules received from SMF 109, in particular packet inspection and different enforcement actions, such as QoS, Charging, etc.;
Control Plane and User Plane separation, CUPS, in particular between Session Management Function, SMF, 109 and User Plane Function, UPF, 112, which is further explained below;
Network Data Analytics Function, NWDAF, 114, is generally used for data collection and data analytics in centralized manner;
Binding Support Function, BSF, not shown in FIGS. 1a and 1b, is generally used to find the PCF 104 in charge of the user Packet Data Unit, PDU, connection policy session in scenarios with more than one PCF 104.

In the Packet Core of the 4G System Architecture:
SCEF (Service Capability Exposure Function) generally plays the role of NEF 102 above, at least for the APIs (Application Programming Interfaces) listed above which are supported also in 4G;
PCRF (Policy and Charging Rules Function) generally plays the role of the PCF 104 above;
network's Home Subscriber Service, HSS, generally plays the role of UDM 105 above;
SCS/AF (Service Capability Server/Application Function) generally plays the role of AF 106 above;
PGW-C(Control plane of the Packet Data Network Gateway) and/or TDF-C(Control plane of the Traffic Detection Function) generally plays the role of the SMF 109 above;
PGW PGW-U (User plane of the Packet Data Network Gateway) and/or TDF-U (User plane of the Traffic Detection Function) generally plays the role of the UPF 112 above.

In the following, Mobile Core will refer to any, the 5G Core or the Packet Core of the 4G System Architecture. Furthermore, CP will refer to any SMF or PGW-C, and UP to any, UPF or PGW-U.

Prior to 3GPP Rel-15, the functional distribution within the core network 100 was based on Network Elements exchanging messages over point to point interfaces. With Rel-15 5G, to facilitate cloud native implementations and deployments, a service-based architecture has been introduced, based on the concept of Network Functions, NF, offering and consuming NF Services over Service Based Interfaces. A service-based Network Function, NF, interaction with other network functions can be generally comprising:
a NF registering in the Network Repository Function, NRF, 103 the list of supported NF services;
other network functions, NFs, can discover the NF services using NRF 103 and selecting a specific instance of the NF;
the network functions NFs consuming NF services of the selected NF instance.

Even after Rel-15 5G, some of the interfaces have been kept as point to point interfaces. This is the case, for instance, of the N4 interface between the Session Management Function, SMF, 109 and the User Plane Function, UPF, 112.

In particular, those two entities belong respectively to the Control Plane, CP, and to the User Plane, UP, of the 5G architecture. Control and user plane separation, CUPS, enables a flexible placement of the separated Control Plane and User Plane functions, for supporting diverse deployment scenarios, for instance central or distributed User Plane function.

In 5G, CUPS relates to SMF 109 and UPF 112 network functions and to the N4 reference point between them, which is based on Packet Forwarding Control Protocol PFCP. The SMF 109 generally controls the packet processing in the UPF 112 by establishing, modifying or deleting PFCP Session contexts and by provisioning, for instance adding, modifying or deleting, PDRs, FARs, QERs, URRs and/or BAR per PFCP session context, whereby an PFCP session context may correspond to an individual PDU session or a standalone PFCP session not tied to any PDU session. Each PDR can contain a PDI, that is, one or more match fields against which incoming packets are matched, and may be associated to the following rules providing the set of instructions to apply to packets matching the PDI:
one FAR, which contains instructions related to the processing of the packets, specifically forward, duplicate, drop or buffer the packet with or without notifying the CP function about the arrival of a DL packet. Each FAR includes what forwarding policies to follow when it comes to N6 traffic steering, e.g. what Service Chain (sequence of Service Functions) is to be applied to the packets;
zero, one or more QERs, which contains instructions related to the QoS enforcement of the traffic;
zero, one or more URRs, which contains instructions related to traffic measurement and reporting.

In CUPS, UPF 112 reports to SMF 109 the capabilities it supports. The current standardized capabilities are:

| Feature | | | |
|---|---|---|---|
| Octet/ | | | |
| Bit | Feature | Interface | Description |
| 5/1 | BUCP | Sxa | Downlink Data Buffering in CP function |
| | | | is supported by the UP function. |
| 5/2 | DDND | Sxa | The buffering parameter ‘Downlink Data |
| | | | Notification Delay’ is supported by the UP |
| | | | function. |
| 5/3 | DLBD | Sxa | The buffering parameter ‘DL Buffering |
| | | | Duration’ is supported by the UP function. |
| 5/4 | TRST | Sxb, Sxc | Traffic Steering is supported by the UP |
| | | | function. |
| 5/5 | FTUP | Sxa, Sxb | F-TEID allocation/release in the UP |
| | | | function is supported by the UP function. |
| 5/6 | PFDM | Sxb, Sxc | The PFD Management procedure is |
| | | | supported by the UP function. |
| 5/7 | HEEU | Sxb, Sxc | Header Enrichment of Uplink traffic is |
| | | | supported by the UP function. |
| 5/8 | TREU | Sxb, Sxc | Traffic Redirection Enforcement in the UP |
| | | | function is supported by the UP function. |
| 6/1 | EMPU | Sxa, Sxb | Sending of End Marker packets supported |
| | | | by the UP function. |
| 6/2 | PDIU | Sxa, Sxb, | Support of PDI optimised signalling in UP |
| | | Sxc, N4 | function (see subclause 5.2.1A.2). |

3GPP specifications 23.501, lists in clause 6.2.3 the functionality included in the UPF 112, but also open the some or all of UPF functionalities to be supported in a single instance of a UPF or distributed over multiple UPF instances.

In particular, several examples of such multiple UPF instances are described in TS 23.501. For example, to ensure connectivity between a RAN node 111 and the anchor UPF 112, an intermediate I-UPF, 112, as illustrated for instance in FIG. 1c, was introduced. The I-UPF 112 is a UPF only executing one Packet Detection Rule, PDR, and one Forwarding Action Rules, FAR. Alternatively, or in addition, as illustrated for instance in FIG. 1d, in order to support the distribution of the point of interconnect to Data Network for data flows with special requirement, for instance low latency connectivity, an Uplink classifier UPF 112 may be combined with several PDU Session Anchor UPFs 112.

Thus, depending on the use case, there is a need of selecting and chain UPFs 112 with different capabilities so as to realize the connectivity service.

3GPP recently launched the “Study on User Plane Function (UPF) enhancement for control and 5G Service Based Architecture (SBA)”, which aims to study the evolution of the UPF 112 as a service-based Network Function integrated with the CP NFs through a Service Based Interface, SBI.

Such service-based approach for the UPF 112 introduces a variety of issues, considering the various uses and configurations of the UPF, as described above.

In general, a service-based UPF would need to register in NRF the exposed services, in line with Service Based Architecture, SBA, principles. A service-based UPF would expose independent services to be consumed by the other CP NFs. This contrast with today's solution, which is a point-to-point, P2P, interface with the SMF based on the PFCP protocol. This results in several unsolved problems when it comes to the support of a service-based UPF in the current 5GC network.

In particular, in the current PFCP-based approach, the association between UPF and SMF is simple, thanks to the presence of the point-to-point, P2P, N4 interface. When introducing a service-based UPF, it is not known how to associate UPFs and SMFs following SBA principles, that is how to manage the association service in the UPF and/or in the SMF. Moreover, in the presence of various UPF and/or SMF, it is not known how to select the UPF/SMF to associate to.

Moreover, in the current PFCP-based approach, the UPF discovery and selection by SMF can be done on a per PDU session basis. When introducing a service-based UPF, it is not known how the SMF can perform service selection on a per PDU session basis. In particular, it is not known what parameters can be considered by the SMF to select the UPF services on a per PDU session basis. It is also not known in what UPFs to do so, for instance considering required capabilities/features coming from PCF, location coming from AMF, UPF location, etc.

Still further, in the current PFCP-based approach, the service chaining functionality can be done in the UPF. When introducing a service-based UPF, it is not known how to configure several services for a given traffic payload chained in a certain order, both within a single UPF and across several UPFs.

Still additionally, a service-based UPF also poses a problem for UPF services usage by other CP NFs. In particular, it is not known how to find the UPF services associated to a certain user. Still further, it is not known how to request services from the consumer.

### SUMMARY

Accordingly, there is a need for techniques which allow for enabling a service-based UPF implementation. This need is met by the features of the independent claims. Further aspects are described in the dependent claims.

According to one aspect, a method for operating a user plane entity in a wireless communication network is provided, the wireless communication network comprising the user plane entity, a plurality of session control entities and a network repository entity,
the plurality of session control entities being configured to handle at least one data packet session in the wireless communication network,
the user plane entity being configured to handle a user plane of the at least one data packet session,
the network repository entity being configured to register the plurality of session control entities and the user plane entity,

the method comprising the steps of:
transmitting to the network repository entity a discovery message comprising:
   an association request indication, for indicating that the user plane entity can be associated to a session control entity,
   filtering criteria for filtering the plurality of session control entities,
receiving from the network repository entity a response message, in response to the discovery message, comprising:
   a list of filtered session control entities, filtered based on the filtering criteria,
transmitting to a first filtered session control entity, of the filtered session control entities, an association request message comprising:
   an identifier of the user plane entity.

Another aspect furthermore relates to a user plane entity for a wireless communication network comprising a processing unit and a memory, the memory comprising instructions configured to cause the processing unit to carry out the steps described above for the method for operating the user plane entity.

According to another aspect, a user plane entity for a wireless communication network is provided, the wireless communication network comprising the user plane entity, a plurality of session control entities and a network repository entity,
the plurality of session control entities being configured to handle at least one data packet session in the wireless communication network,
the user plane entity being configured to handle a user plane of the at least one data packet session,
the network repository entity being configured to register the plurality of session control entities and the user plane entity,

the user plane entity comprising:
a module for transmitting to the network repository entity a discovery message comprising:
   an association request indication, for indicating that the user plane entity can be associated to a session control entity,
   filtering criteria for filtering the plurality of session control entities,
a module for receiving from the network repository entity a response message, in response to the discovery message, comprising:
   a list of filtered session control entities, filtered based on the filtering criteria,
a module for transmitting to a first filtered session control entity, of the filtered session control entities, an association request message comprising:
   an identifier of the user plane entity.

According to another aspect, a method for operating a session control entity in a wireless communication network is provided, the wireless communication network comprising a user plane entity, a plurality of session control entities and a network repository entity,
the plurality of session control entities being configured to handle at least one data packet session in the wireless communication network,
the user plane entity being configured to handle a user plane of the at least one data packet session,
the network repository entity being configured to register the plurality of session control entities and the user plane entity,

the method comprising the steps of:
transmitting to the network repository entity a registration message comprising:
   an association service indication, for indicating that the session control entity can be associated to a user plane entity,
   an area indication of the session control entity,
receiving from the user plane entity an association request message comprising:
   an identifier of the user plane entity.

Another aspect furthermore relates to a session control entity for a wireless communication network comprising a processing unit and a memory, the memory comprising instructions configured to cause the processing unit to carry out the steps described above for the method for operating the session control entity.

According to another aspect, a session control entity for a wireless communication network is provided, the wireless communication network comprising a user plane entity, a plurality of session control entities and a network repository entity,
the plurality of session control entities being configured to handle at least one data packet session in the wireless communication network,
the user plane entity being configured to handle a user plane of the at least one data packet session,
the network repository entity being configured to register the plurality of session control entities and the user plane entity,

the session control entity comprising:
a module for transmitting to the network repository entity a registration message comprising:
   an association service indication, for indicating that the session control entity can be associated to a user plane entity,
   an area indication of the session control entity,
a module for receiving from the user plane entity an association request message comprising:
   an identifier of the user plane entity.

According to another aspect, a method for operating a network repository entity in a wireless communication network is provided, the wireless communication network comprising a user plane entity, a plurality of session control entities and the network repository entity,
the plurality of session control entities being configured to handle at least one data packet session in the wireless communication network,
the user plane entity being configured to handle a user plane of the at least one data packet session,
the network repository entity being configured to register the plurality of session control entities and the user plane entity,

the method comprising the steps of:
receiving from at least one of the plurality of session control entities a registration message comprising:
   an association service indication, for indicating that the at least one session control entity can be associated to a user plane entity,
   an area indication of the at least one session control entity,
receiving from the user plane entity a discovery message comprising:
   an association request indication, indicating that the user plane entity can be associated to a session control entities,
   filtering criteria for filtering the plurality of session control entities,
transmitting to the user plane entity a response message, in response to the discovery message, comprising:
   a list of filtered session control entities, filtered based on the filtering criteria.

Another aspect furthermore relates to a network repository entity for a wireless communication network comprising a processing unit and a memory, the memory comprising instructions configured to cause the processing unit to carry out the steps described above for the method for operating the network repository entity.

According to another aspect, a network repository entity for a wireless communication network is provided, the wireless communication network comprising a user plane entity, a plurality of session control entities and the network repository entity,
the plurality of session control entities being configured to handle at least one data packet session in the wireless communication network,
the user plane entity being configured to handle a user plane of the at least one data packet session,
the network repository entity being configured to register the plurality of session control entities and the user plane entity,

the network repository entity comprising:
a module for receiving from at least one of the plurality of session control entities a registration message comprising:
   an association service indication, for indicating that the at least one session control entity can be associated to a user plane entity,
   an area indication of the at least one session control entity,
a module for receiving from the user plane entity a discovery message comprising:
   an association request indication, indicating that the user plane entity can be associated to a session control entities,
   filtering criteria for filtering the plurality of session control entities,
a module for transmitting to the user plane entity a response message, in response to the discovery message, comprising:
   a list of filtered session control entities, filtered based on the filtering criteria.

According to another aspect, a method for operating a user plane entity in a wireless communication network is provided, the wireless communication network comprising a plurality of user plane entities, a session control entity and a network repository entity,
the session control entity being configured to handle at least one data packet session in the wireless communication network,
the plurality of user plane entities being configured to handle a user plane of the at least one data packet session,
the network repository entity being configured to register the session control entity and the plurality of user plane entities,

the method comprising the steps of:
transmitting to the network repository entity a registration message comprising:
   an association service indication, for indicating that the user plane entity can be associated to a session control entity,
receiving from the session control entity an association request message comprising:
   an identifier of the session control entity,
transmitting to the session control entity an association confirmation message, in response to the association request message.

Another aspect furthermore relates to a user plane entity for a wireless communication network comprising a processing unit and a memory, the memory comprising instructions configured to cause the processing unit to carry out the steps described above for the method for operating the user plane entity.

According to another aspect, a user plane entity for a wireless communication network is provided, the wireless communication network comprising a plurality of user plane entities, a session control entity and a network repository entity,
the session control entity being configured to handle at least one data packet session in the wireless communication network,
the plurality of user plane entities being configured to handle a user plane of the at least one data packet session,
the network repository entity being configured to register the session control entity and the plurality of user plane entities,

the user plane entity comprising:
a module for transmitting to the network repository entity a registration message comprising:
   an association service indication, for indicating that the user plane entity can be associated to a session control entity,
a module for receiving from the session control entity an association request message comprising:
   an identifier of the session control entity,
a module for transmitting to the session control entity an association confirmation message, in response to the association request message.

According to another aspect, a method for operating a session control entity in a wireless communication network is provided, the wireless communication network comprising a plurality of user plane entities, the session control entity and a network repository entity,
the session control entity being configured to handle at least one data packet session in the wireless communication network,
the plurality of user plane entities being configured to handle a user plane of the at least one data packet session,
the network repository entity being configured to register the session control entity and the plurality of user plane entities,

the method comprising the steps of:
transmitting to the network repository entity a discovery message comprising:
   an association request indication, for indicating that the session control entity can be associated to a user plane entity,
   filtering criteria for filtering the plurality of user plane entities,
receiving from the network repository entity a response message, in response to the discovery message, comprising:
   a list of filtered user plane entities, filtered based on the filtering criteria,
transmitting to a first filtered user plane entity, of the filtered user plane entities, an association request message comprising:
   an identifier of the session control entity.

Another aspect furthermore relates to a session control entity for a wireless communication network comprising a processing unit and a memory, the memory comprising instructions configured to cause the processing unit to carry out the steps described above for the method for operating the session control entity.

According to another aspect, a session control entity for a wireless communication network is provided, the wireless communication network comprising a plurality of user plane entities, the session control entity and a network repository entity,
the session control entity being configured to handle at least one data packet session in the wireless communication network,
the plurality of user plane entities being configured to handle a user plane of the at least one data packet session,
the network repository entity being configured to register the session control entity and the plurality of user plane entities,

the session control entity comprising:
a module for transmitting to the network repository entity a discovery message comprising:
   an association request indication, for indicating that the session control entity can be associated to a user plane entity,
   filtering criteria for filtering the plurality of user plane entities,
a module for receiving from the network repository entity a response message, in response to the discovery message, comprising:
   a list of filtered user plane entities, filtered based on the filtering criteria,
a module for transmitting to a first filtered user plane entity, of the filtered user plane entities, an association request message comprising:
   an identifier of the session control entity.

According to another aspect, a method for operating a network repository entity in a wireless communication network is provided, the wireless communication network comprising a plurality of user plane entities, a session control entity and the network repository entity,
the session control entity being configured to handle at least one data packet session in the wireless communication network,
the plurality of user plane entities being configured to handle a user plane of the at least one data packet session,
the network repository entity being configured to register the session control entity and the plurality of user plane entities,

the method comprising the steps of:
receiving from at least one of the user plane entities a registration message comprising:
   an association service indication, for indicating that the at least one user plane entity can be associated to a session control entity,
receiving from the session control entity a discovery message comprising:
   an association request indication, for indicating that the session control entity can be associated to a user plane entity,
   filtering criteria for filtering the plurality of user plane entities,
transmitting to the session control entity a response message, in response to the discovery message, comprising:
   a list of filtered user plane entities, filtered based on the filtering criteria.

Another aspect furthermore relates to a network repository entity for a wireless communication network comprising a processing unit and a memory, the memory comprising instructions configured to cause the processing unit to carry out the steps described above for the method for operating the network repository entity.

According to another aspect, a network repository entity for a wireless communication network is provided, the wireless communication network comprising a plurality of user plane entities, a session control entity and the network repository entity,
the session control entity being configured to handle at least one data packet session in the wireless communication network,
the plurality of user plane entities being configured to handle a user plane of the at least one data packet session,
the network repository entity being configured to register the session control entity and the plurality of user plane entities,

the network repository entity comprising:
a module for receiving from at least one of the user plane entities a registration message comprising:
   an association service indication, for indicating that the at least one user plane entity can be associated to a session control entity,
a module for receiving from the session control entity a discovery message comprising:
   an association request indication, for indicating that the session control entity can be associated to a user plane entity,
   filtering criteria for filtering the plurality of user plane entities,
a module for transmitting to the session control entity a response message, in response to the discovery message, comprising:
   a list of filtered user plane entities, filtered based on the filtering criteria.

According to another aspect, a method for operating a session control entity in a wireless communication network is provided, the wireless communication network comprising a plurality of user plane entities, the session control entity, a policy control entity, and a network repository entity,
the session control entity being configured to handle at least one data packet session in the wireless communication network,
the plurality of user plane entities being configured to handle a user plane of the at least one data packet session,
the policy control entity being configured to handle a policy plane of the at least one data packet session,
the network repository entity being configured to register the plurality of session control entities and the user plane entity,

the method comprising the steps of:
receiving from the policy control entity a policy activation message comprising:
   a list of services to be activated in the plurality of user plane entities,
transmitting to the network repository entity a discovery message comprising:
   filtering criteria for filtering the plurality of user plane entities,
receiving from the network repository entity a response message, in response to the discovery message, comprising:
   a list of filtered user plane entities, filtered based on the filtering criteria.

Another aspect furthermore relates to a session control entity for a wireless communication network comprising a processing unit and a memory, the memory comprising instructions configured to cause the processing unit to carry out the steps described above for the method for operating the session control entity.

According to another aspect, a session control entity for a wireless communication network is provided, the wireless communication network comprising a plurality of user plane entities, the session control entity, a policy control entity, and a network repository entity,
the session control entity being configured to handle at least one data packet session in the wireless communication network,
the plurality of user plane entities being configured to handle a user plane of the at least one data packet session,
the policy control entity being configured to handle a policy plane of the at least one data packet session,
the network repository entity being configured to register the plurality of session control entities and the user plane entity,

the session control entity comprising:
a module for receiving from the policy control entity a policy activation message comprising:
   a list of services to be activated in the plurality of user plane entities,
a module for transmitting to the network repository entity a discovery message comprising:
   filtering criteria for filtering the plurality of user plane entities,
a module for receiving from the network repository entity a response message, in response to the discovery message, comprising:
   a list of filtered user plane entities, filtered based on the filtering criteria.

According to another aspect, a method for operating a session control entity in a wireless communication network is provided, the wireless communication network comprising a user plane entity, the session control entity, a user repository entity, and a wireless communication network entity,
the session control entity being configured to handle at least one data packet session in the wireless communication network,
the user plane entity being configured to handle a user plane of the at least one data packet session,
the user repository entity being configured to register subscriber information for users of the wireless communication network,
the wireless communication network entity being an entity of the wireless communication network accessing services of at least the user plane entity,

the method comprising the steps of:
receiving from the wireless communication network entity a service discovery message comprising:
   a service indication, for indicating a service provided by the user plane entity,
   an identifier of a user of the wireless communication network,
transmitting to the wireless communication network entity a response message, in response to the service discovery message, comprising:
   an address of the user plane entity.

Another aspect furthermore relates to a session control entity for a wireless communication network comprising a processing unit and a memory, the memory comprising instructions configured to cause the processing unit to carry out the steps described above for the method for operating the session control entity.

According to another aspect, a session control entity for a wireless communication network is provided, the wireless communication network comprising a user plane entity, the session control entity, a user repository entity, and a wireless communication network entity,
the session control entity being configured to handle at least one data packet session in the wireless communication network,
the user plane entity being configured to handle a user plane of the at least one data packet session,
the user repository entity being configured to register subscriber information for users of the wireless communication network,
the wireless communication network entity being an entity of the wireless communication network accessing services of at least the user plane entity,

the session control entity comprising:
a module for receiving from the wireless communication network entity a service discovery message comprising:
   a service indication, for indicating a service provided by the user plane entity,
   an identifier of a user of the wireless communication network,
a module for transmitting to the wireless communication network entity a response message, in response to the service discovery message, comprising:
   an address of the user plane entity.

According to another aspect, a method for operating a wireless communication network entity in a wireless communication network is provided, the wireless communication network comprising a user plane entity, a session control entity, a user repository entity, and the wireless communication network entity,
the session control entity being configured to handle at least one data packet session in the wireless communication network,
the user plane entity being configured to handle a user plane of the at least one data packet session,
the user repository entity being configured to register subscriber information for users of the wireless communication network,
the wireless communication network entity being an entity of the wireless communication network accessing services of at least the user plane entity,

the method comprising the steps of:
transmitting to the session control entity a service discovery message comprising:
   a service indication, for indicating a service provided by the user plane entity,
   an identifier of a user of the wireless communication network,
receiving from the session control entity a response message, in response to the service discovery message, comprising:
   an address of the user plane entity.

Another aspect furthermore relates to a wireless communication network entity for a wireless communication network comprising a processing unit and a memory, the memory comprising instructions configured to cause the processing unit to carry out the steps described above for the method for operating the wireless communication network entity.

According to another aspect, a wireless communication network entity for a wireless communication network is provided, the wireless communication network comprising a user plane entity, a session control entity, a user repository entity, and the wireless communication network entity,
the session control entity being configured to handle at least one data packet session in the wireless communication network,
the user plane entity being configured to handle a user plane of the at least one data packet session,
the user repository entity being configured to register subscriber information for users of the wireless communication network,
the wireless communication network entity being an entity of the wireless communication network accessing services of at least the user plane entity,

the wireless communication network entity comprising:
a module for transmitting to the session control entity a service discovery message comprising:
   a service indication, for indicating a service provided by the user plane entity,
   an identifier of a user of the wireless communication network,
a module for receiving from the session control entity a response message, in response to the service discovery message, comprising:
   an address of the user plane entity.

According to another aspect, a method for operating a user repository entity in a wireless communication network is provided, the wireless communication network comprising a user plane entity, a session control entity, the user repository entity, and a wireless communication network entity,
the session control entity being configured to handle at least one data packet session in the wireless communication network,
the user plane entity being configured to handle a user plane of the at least one data packet session,
the user repository entity being configured to register subscriber information for users of the wireless communication network,
the wireless communication network entity being an entity of the wireless communication network accessing services of at least the user plane entity,

the method comprising the steps of:
receiving from the session control entity a service registration message comprising:
   a service indication, for indicating a service provided by the user plane entity,
   an identifier of a user of the wireless communication network,
receiving from the wireless communication network entity a service discovery message comprising:
   the identifier of the user of the wireless communication network,
transmitting to the wireless communication network entity a response message, in response to the service discovery message, comprising:
   an address of the user plane entity.

Another aspect furthermore relates to a user repository entity for a wireless communication network comprising a processing unit and a memory, the memory comprising instructions configured to cause the processing unit to carry out the steps described above for the method for operating the user repository entity.

According to another aspect, a user repository entity for a wireless communication network is provided, the wireless communication network comprising a user plane entity, a session control entity, the user repository entity, and a wireless communication network entity,
the session control entity being configured to handle at least one data packet session in the wireless communication network,
the user plane entity being configured to handle a user plane of the at least one data packet session,
the user repository entity being configured to register subscriber information for users of the wireless communication network,
the wireless communication network entity being an entity of the wireless communication network accessing services of at least the user plane entity,

the user repository entity comprising:
a module for receiving from the session control entity a service registration message comprising:
   a service indication, for indicating a service provided by the user plane entity,
   an identifier of a user of the wireless communication network,
a module for receiving from the wireless communication network entity a service discovery message comprising:
   the identifier of the user of the wireless communication network,
a module for transmitting to the wireless communication network entity a response message, in response to the service discovery message, comprising:
   an address of the user plane entity.

According to another aspect, a method for operating a session control entity in a wireless communication network is provided, the wireless communication network comprising a user plane entity, the session control entity, a user repository entity, and a wireless communication network entity,
the session control entity being configured to handle at least one data packet session in the wireless communication network,
the user plane entity being configured to handle a user plane of the at least one data packet session,
the user repository entity being configured to register subscriber information for users of the wireless communication network,
the wireless communication network entity being an entity of the wireless communication network accessing services of at least the user plane entity,

the method comprising the steps of:
selecting services provided by the user plane entity;
transmitting to the user repository entity a service registration message comprising:
   a service indication, for indicating a service provided by the user plane entity,
   an identifier of a user of the wireless communication network.

Another aspect furthermore relates to a session control entity for a wireless communication network comprising a processing unit and a memory, the memory comprising instructions configured to cause the processing unit to carry out the steps described above for the method for operating the session control entity.

According to another aspect, a session control entity for a wireless communication network is provided, the wireless communication network comprising a user plane entity, the session control entity, a user repository entity, and a wireless communication network entity,
the session control entity being configured to handle at least one data packet session in the wireless communication network,
the user plane entity being configured to handle a user plane of the at least one data packet session,
the user repository entity being configured to register subscriber information for users of the wireless communication network,
the wireless communication network entity being an entity of the wireless communication network accessing services of at least the user plane entity,

the session control entity comprising:
a module for selecting services provided by the user plane entity;
a module for transmitting to the user repository entity a service registration message comprising:
   a service indication, for indicating a service provided by the user plane entity,
   an identifier of a user of the wireless communication network.

According to another aspect, a method for operating a wireless communication network entity in a wireless communication network is provided, the wireless communication network comprising a user plane entity, a session control entity, a user repository entity, and the wireless communication network entity,
the session control entity being configured to handle at least one data packet session in the wireless communication network,
the user plane entity being configured to handle a user plane of the at least one data packet session,
the user repository entity being configured to register subscriber information for users of the wireless communication network,
the wireless communication network entity being an entity of the wireless communication network accessing services of at least the user plane entity,

the method comprising the steps of:
transmitting to the user repository entity a service discovery message comprising:
   an identifier of a user of the wireless communication network,
receiving from the user repository entity a response message, in response to the service discovery message, comprising:
   an address of the user plane entity.

Another aspect furthermore relates to a wireless communication network entity for a wireless communication network comprising a processing unit and a memory, the memory comprising instructions configured to cause the processing unit to carry out the steps described above for the method for operating the wireless communication network entity.

According to another aspect, a wireless communication network entity for a wireless communication network is provided, the wireless communication network comprising a user plane entity, a session control entity, a user repository entity, and the wireless communication network entity,
the session control entity being configured to handle at least one data packet session in the wireless communication network,
the user plane entity being configured to handle a user plane of the at least one data packet session,
the user repository entity being configured to register subscriber information for users of the wireless communication network,
the wireless communication network entity being an entity of the wireless communication network accessing services of at least the user plane entity,

the wireless communication network entity comprising:
a module for transmitting to the user repository entity a service discovery message comprising:
   an identifier of a user of the wireless communication network,
a module for receiving from the user repository entity a response message, in response to the service discovery message, comprising:
   an address of the user plane entity.

According to another aspect, a method for operating a session control entity in a wireless communication network is provided, the wireless communication network comprising a user plane entity, the session control entity, a user repository entity, and a wireless communication network entity,
the session control entity being configured to handle at least one data packet session in the wireless communication network,
the user plane entity being configured to handle a user plane of the at least one data packet session,
the user repository entity being configured to register subscriber information for users of the wireless communication network,
the wireless communication network entity being an entity of the wireless communication network accessing services of at least the user plane entity,

the method comprising the steps of:
receiving from the wireless communication network entity a service registration message comprising:
   a service indication, for indicating a service provided by the user plane entity,
   an identifier of a user of the wireless communication network,
transmitting to the user plane entity a subscription message, in response to the service registration message, for subscribing the wireless communication network entity to the service indicated by the service indication.

Another aspect furthermore relates to a session control entity for a wireless communication network comprising a processing unit and a memory, the memory comprising instructions configured to cause the processing unit to carry out the steps described above for the method for operating the session control entity.

According to another aspect, a session control entity for a wireless communication network is provided, the wireless communication network comprising a user plane entity, the session control entity, a user repository entity, and a wireless communication network entity,
the session control entity being configured to handle at least one data packet session in the wireless communication network,
the user plane entity being configured to handle a user plane of the at least one data packet session,
the user repository entity being configured to register subscriber information for users of the wireless communication network,
the wireless communication network entity being an entity of the wireless communication network accessing services of at least the user plane entity,

the session control entity comprising:
a module for receiving from the wireless communication network entity a service registration message comprising:
   a service indication, for indicating a service provided by the user plane entity,
   an identifier of a user of the wireless communication network,
a module for transmitting to the user plane entity a subscription message, in response to the service registration message, for subscribing the wireless communication network entity to the service indicated by the service indication.

According to another aspect, a method for operating a wireless communication network entity in a wireless communication network is provided, the wireless communication network comprising a user plane entity, a session control entity, a user repository entity, and the wireless communication network entity,
the session control entity being configured to handle at least one data packet session in the wireless communication network,
the user plane entity being configured to handle a user plane of the at least one data packet session,
the user repository entity being configured to register subscriber information for users of the wireless communication network,
the wireless communication network entity being an entity of the wireless communication network accessing services of at least the user plane entity,

the method comprising the steps of:
transmitting to the user repository entity a session control discovery message, comprising:
   an identifier of a user of the wireless communication network,
receiving from the user repository entity a session control indication message, in response to the session control discovery message, comprising:
   the address of the session control entity,
transmitting to the session control entity a service registration message comprising:
   a service indication, for indicating a service provided by the user plane entity,
   the identifier of the user of the wireless communication network.

Another aspect furthermore relates to a wireless communication network entity for a wireless communication network comprising a processing unit and a memory, the memory comprising instructions configured to cause the processing unit to carry out the steps described above for the method for operating the wireless communication network entity.

According to another aspect, a wireless communication network entity for a wireless communication network is provided, the wireless communication network comprising a user plane entity, a session control entity, a user repository entity, and the wireless communication network entity,
the session control entity being configured to handle at least one data packet session in the wireless communication network,
the user plane entity being configured to handle a user plane of the at least one data packet session,
the user repository entity being configured to register subscriber information for users of the wireless communication network,
the wireless communication network entity being an entity of the wireless communication network accessing services of at least the user plane entity,

the wireless communication network entity comprising:
a module for transmitting to the user repository entity a session control discovery message, comprising:
   an identifier of a user of the wireless communication network,
a module for receiving from the user repository entity a session control indication message, in response to the session control discovery message, comprising:
   the address of the session control entity,
a module for transmitting to the session control entity a service registration message comprising:
   a service indication, for indicating a service provided by the user plane entity,
   the identifier of the user of the wireless communication network.

It is to be understood that the features mentioned above and features yet to be explained below can be used not only in the respective combinations indicated, but also in other combinations or in isolation without departing from the scope of the present invention. Features of the above-mentioned aspects and embodiments described below may be combined with each other in other embodiments unless explicitly mentioned otherwise.

Other devices, systems, methods, features and advantages will be or will become apparent to one with skill in the art upon examination of the following detailed description and figures. It is intended that all such additional systems, methods, features and advantages be included within this description, be within the scope of the invention and be protected by the following claims.

### DETAILED DESCRIPTION OF DRAWINGS

Various features of embodiments will become more apparent when read in conjunction with the accompanying drawings. In these drawings:

FIG. 1a schematically illustrates the 5G NR reference architecture as currently defined by 3GPP;

FIG. 1b schematically illustrates 5GC architecture for policy, charging and analytics;

FIG. 1c schematically illustrates an implementation including an intermediate I-UPF between a RAN node and the anchor UPF;

FIG. 1d schematically illustrates an implementation including an Uplink classifier UPF 112, combined with several PDU Session Anchor UPFs 112;

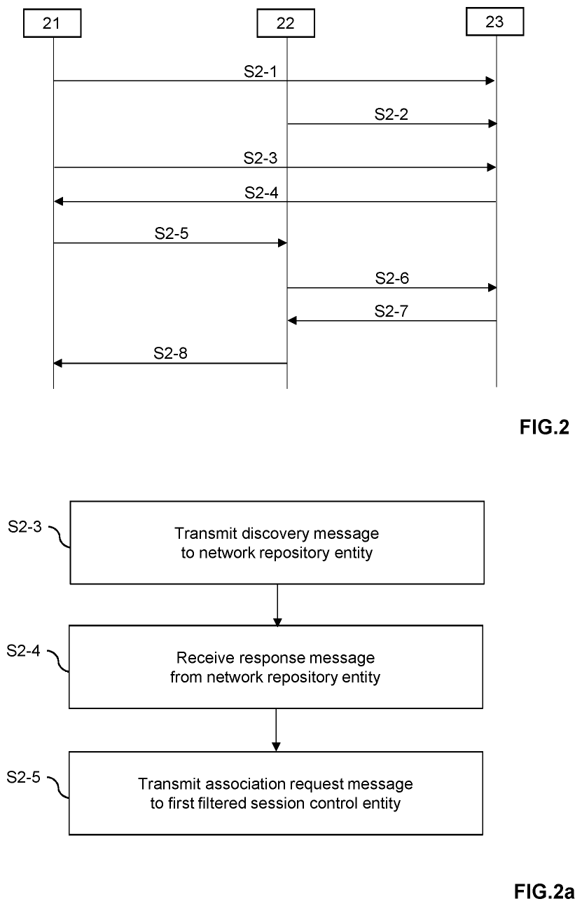

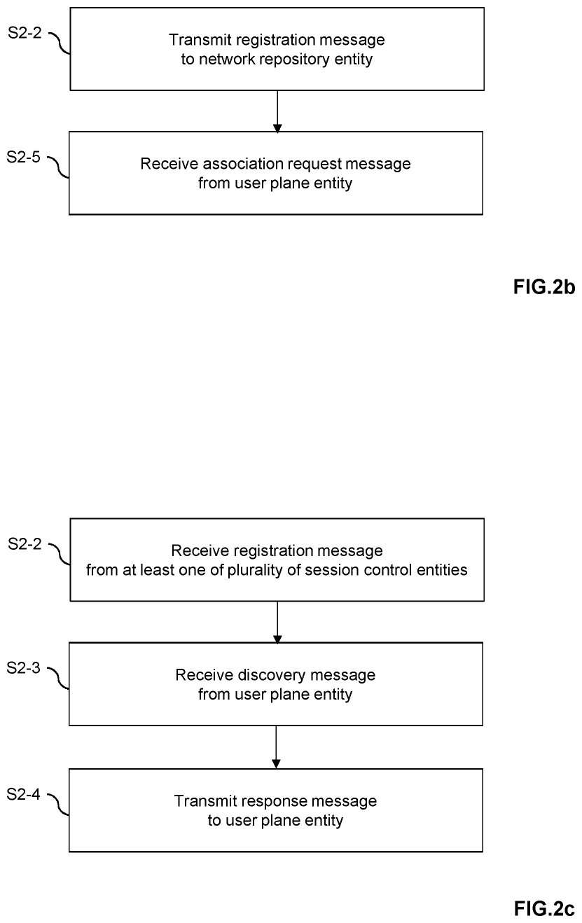

FIG. 2 shows an example flowchart of a method for operating entities of a wireless communication network for associating a service-based user plane entity and a session control entity;

FIG. 2a shows an example flowchart of a method for operating a user plane entity of a wireless communication network for associating a service-based user plane entity and a session control entity;

FIG. 2b shows an example flowchart of a method for operating a session control entity of a wireless communication network for associating a service-based user plane entity and a session control entity;

FIG. 2c shows an example flowchart of a method for operating a network repository entity of a wireless communication network for associating a service-based user plane entity and a session control entity;

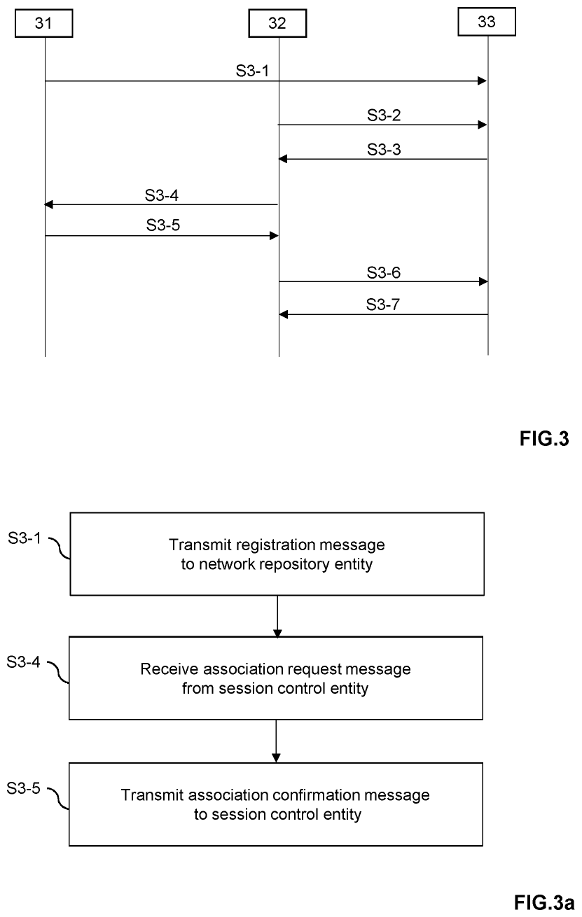

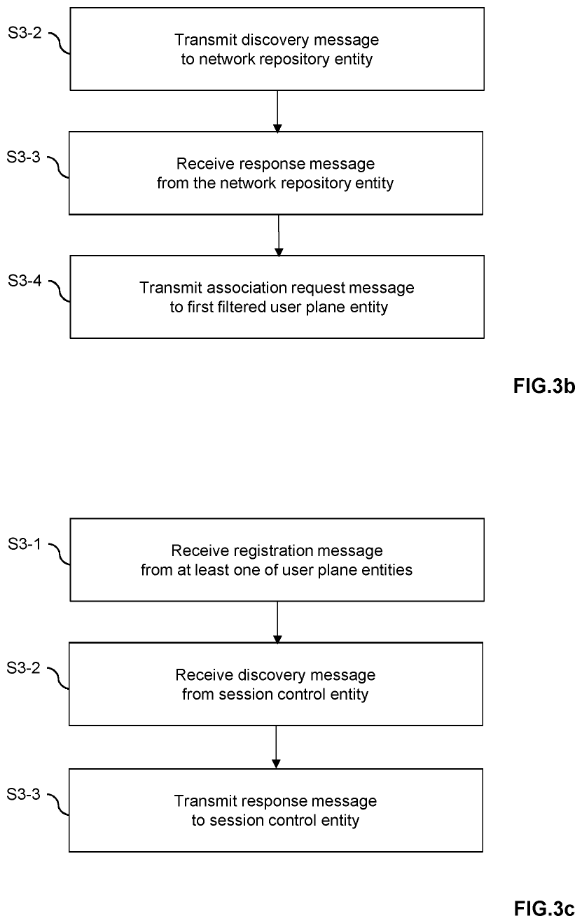

FIG. 3 shows an example flowchart of a method for operating entities of a wireless communication network for associating a service-based user plane entity and a session control entity;

FIG. 3a shows an example flowchart of a method for operating a user plane entity of a wireless communication network for associating a service-based user plane entity and a session control entity;

FIG. 3b shows an example flowchart of a method for operating a session control entity of a wireless communication network for associating a service-based user plane entity and a session control entity;

FIG. 3c shows an example flowchart of a method for operating a network repository entity of a wireless communication network for associating a service-based user plane entity and a session control entity;

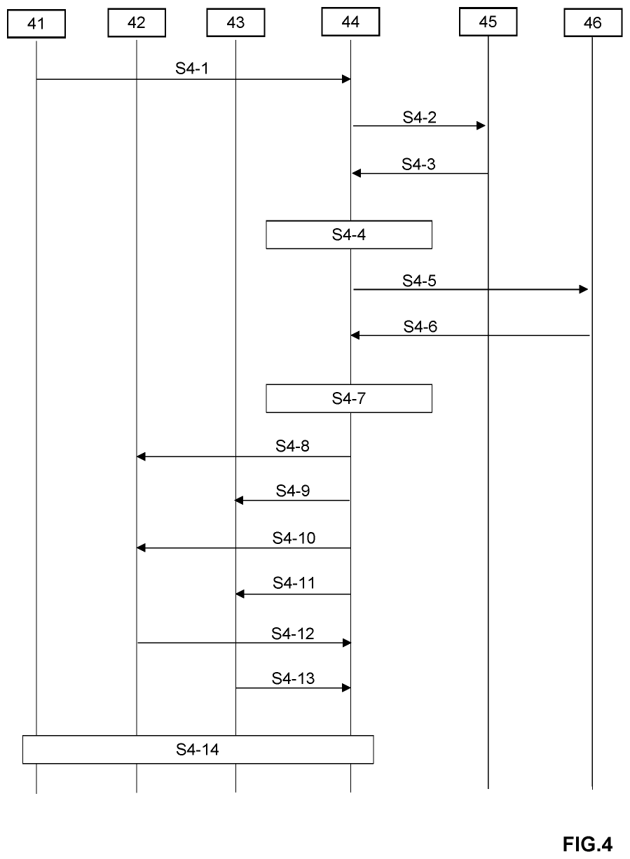

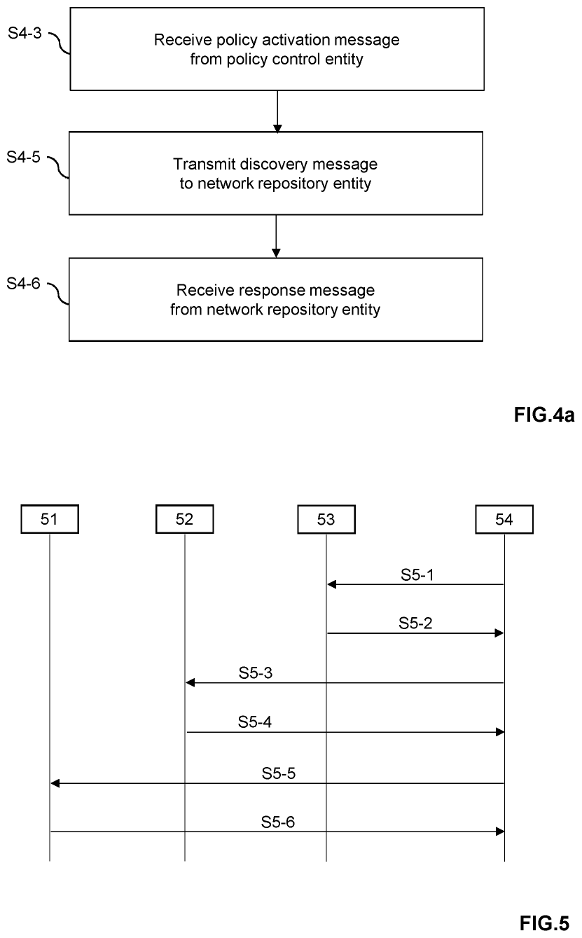

FIG. 4 shows an example flowchart of a method for operating entities of a wireless communication network for establishing a PDU session;

FIG. 4a shows an example flowchart of a method for operating a session control entity of a wireless communication network for establishing a PDU session;

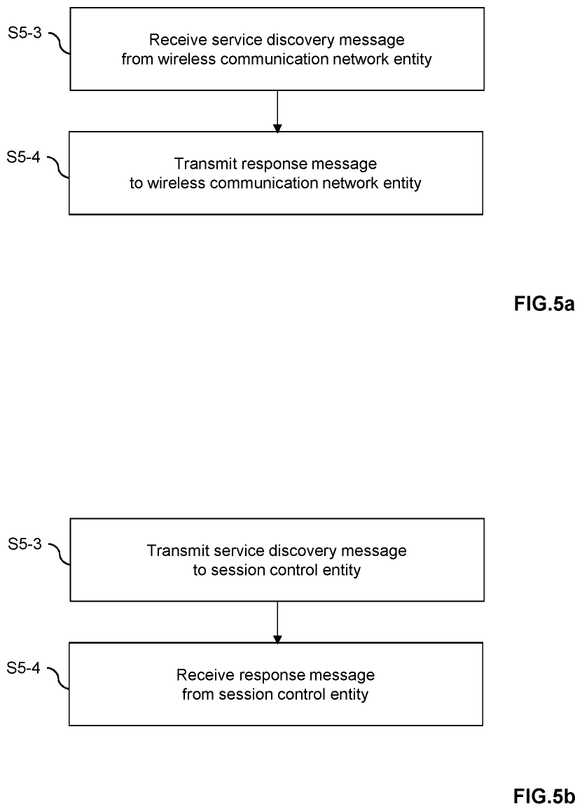

FIG. 5 shows an example flowchart of a method for operating entities of a wireless communication network for accessing services of a service-based user plane entity;

FIG. 5a shows an example flowchart of a method for operating a session control entity of a wireless communication network for accessing services of a service-based user plane entity;

FIG. 5b shows an example flowchart of a method for operating a wireless communication network entity of a wireless communication network for accessing services of a service-based user plane entity;

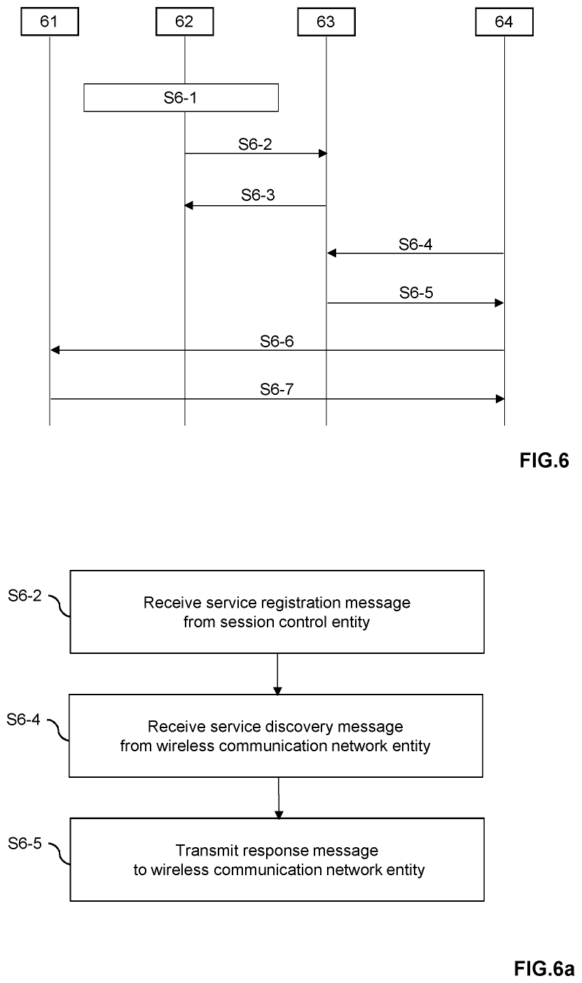

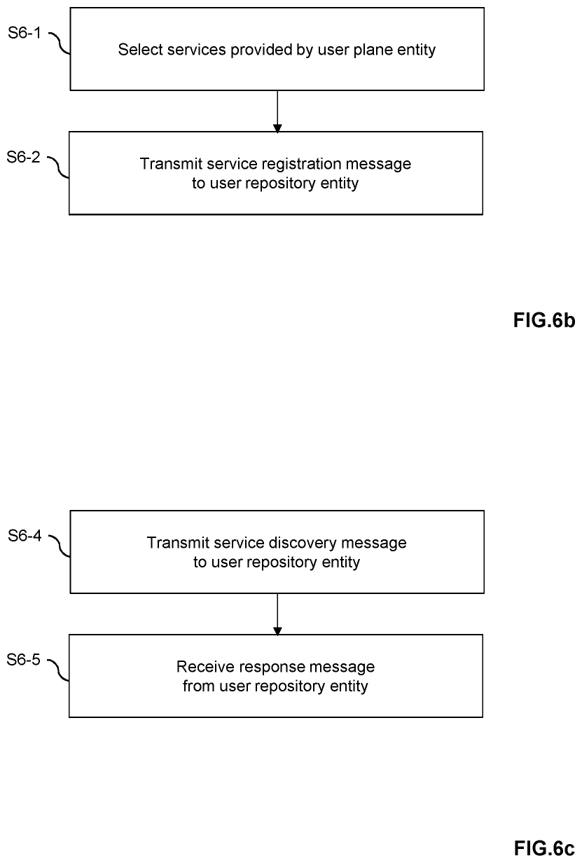

FIG. 6 shows an example flowchart of a method for operating entities of a wireless communication network for accessing services of a service-based user plane entity;

FIG. 6a shows an example flowchart of a method for operating a user repository entity of a wireless communication network for accessing services of a service-based user plane entity;

FIG. 6b shows an example flowchart of a method for operating a session control entity of a wireless communication network for accessing services of a service-based user plane entity;

FIG. 6c shows an example flowchart of a method for operating a wireless communication network entity of a wireless communication network for accessing services of a service-based user plane entity;

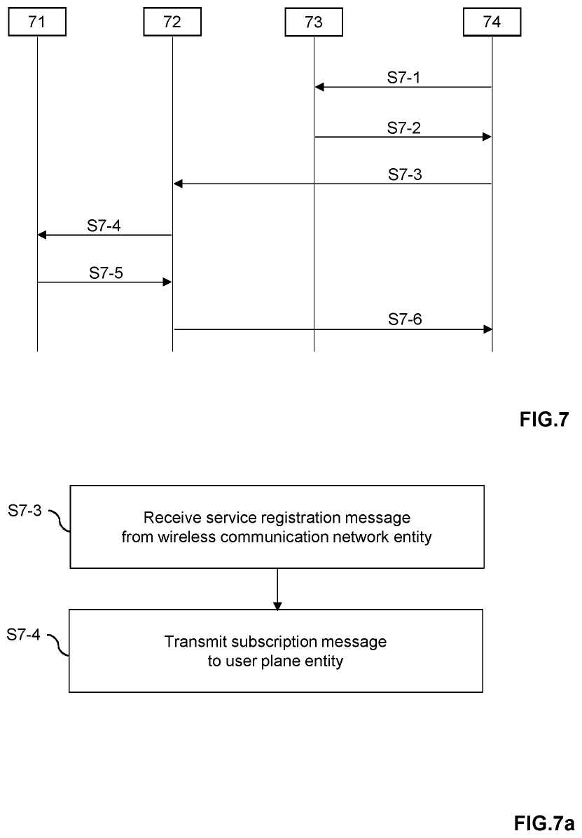

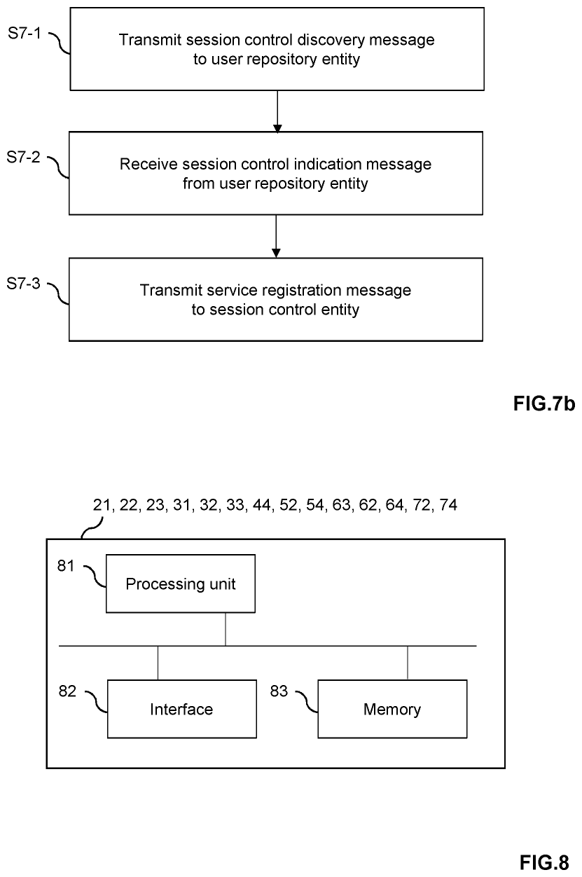

FIG. 7 shows an example flowchart of a method for operating entities of a wireless communication network for accessing services of a service-based user plane entity;

FIG. 7a shows an example flowchart of a method for operating a session control entity of a wireless communication network for accessing services of a service-based user plane entity;

FIG. 7b shows an example flowchart of a method for operating a wireless communication network entity of a wireless communication network for accessing services of a service-based user plane entity;

FIG. 8 shows an example schematic of various entities of a wireless communication network allowing implementation of a service-based user plane entity;

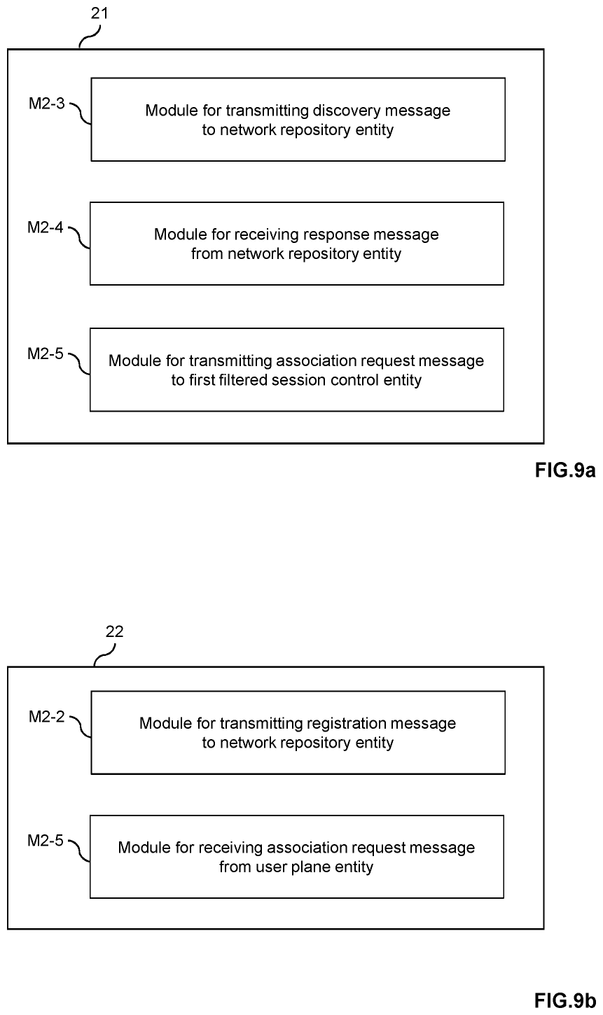

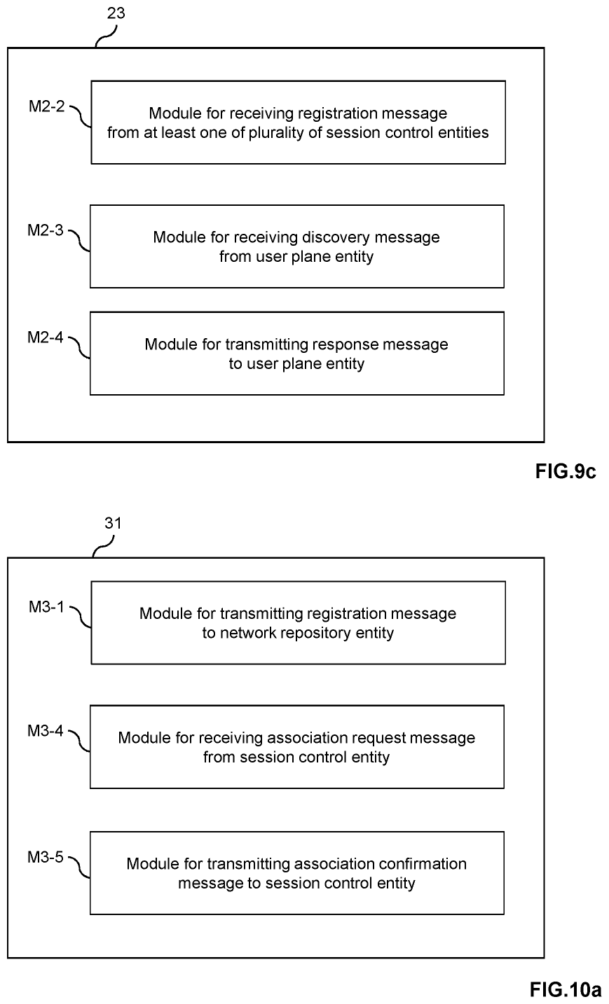

FIG. 9a shows an example user plane entity of a wireless communication network;

FIG. 9b shows an example session control entity of a wireless communication network;

FIG. 9c shows an example network repository entity of a wireless communication network;

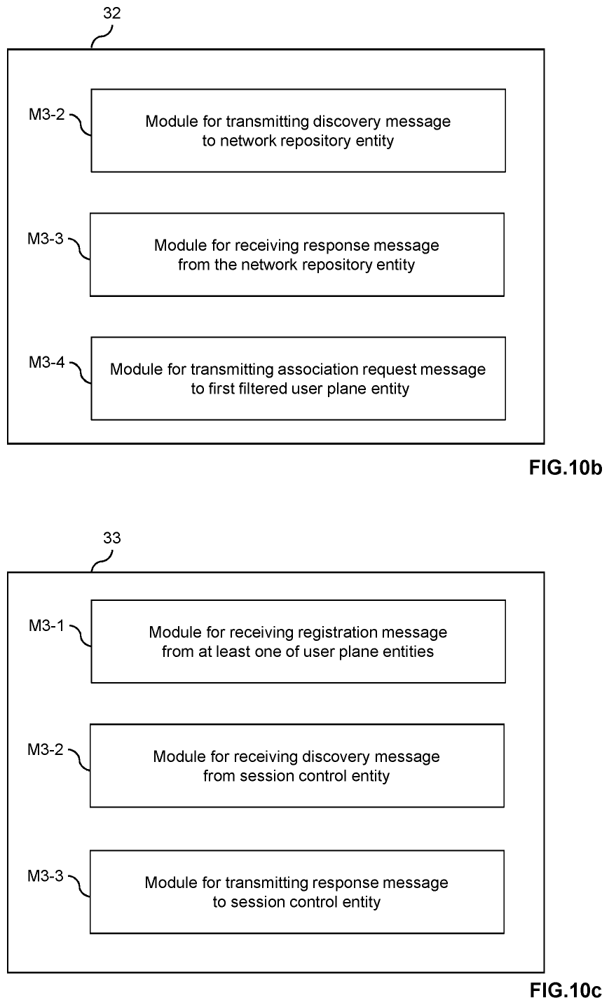

FIG. 10a shows an example user plane entity of a wireless communication network;

FIG. 10b shows an example session control entity of a wireless communication network;

FIG. 10c shows an example network repository entity of a wireless communication network;

FIG. 11a shows an example session control entity of a wireless communication network;

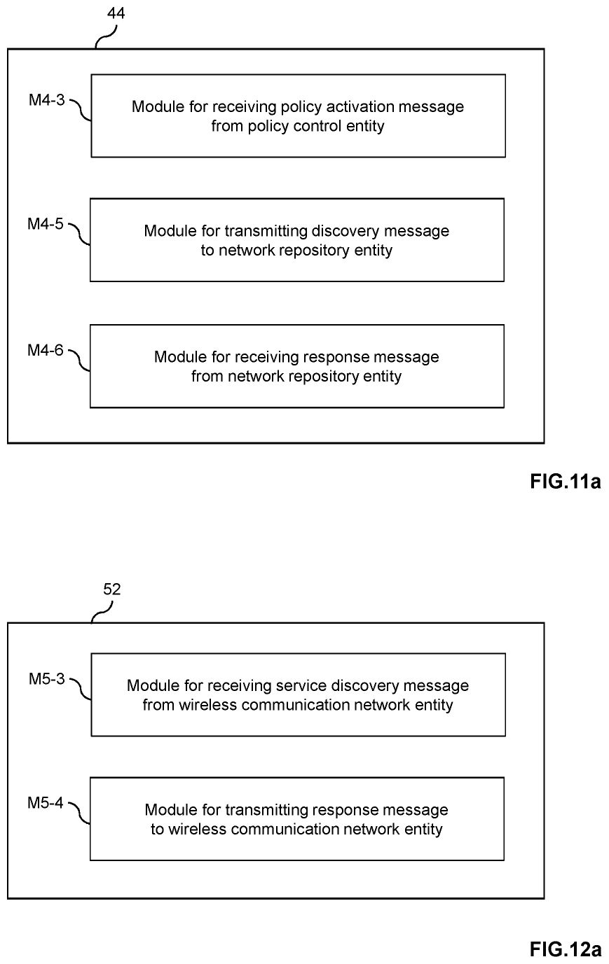

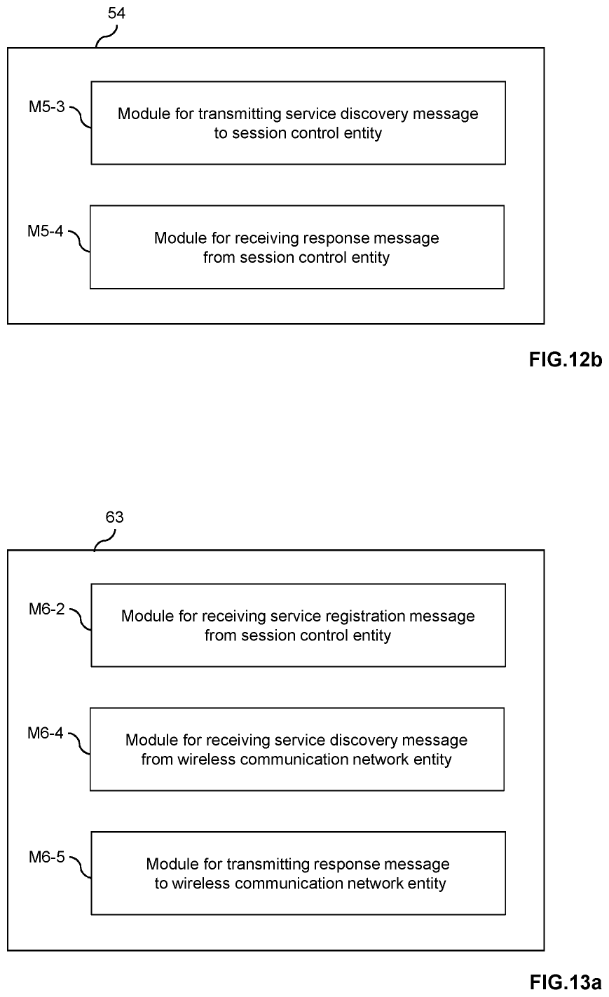

FIG. 12a shows an example session control entity of a wireless communication network;

FIG. 12b shows an example wireless communication network entity of a wireless communication network;

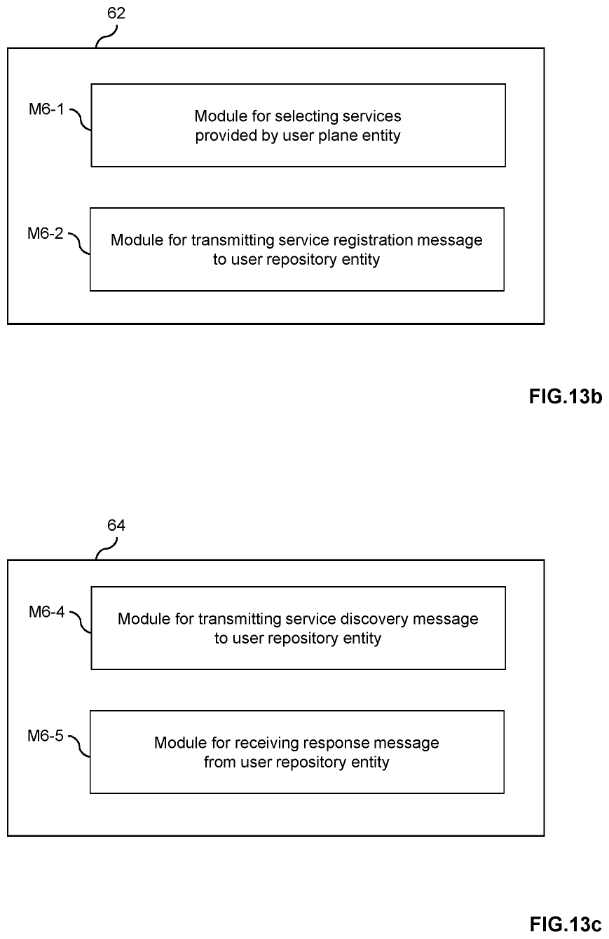

FIG. 13a shows an example user repository entity of a wireless communication network;

FIG. 13b shows an example session control entity of a wireless communication network;

FIG. 13c shows an example wireless communication network entity of a wireless communication network;

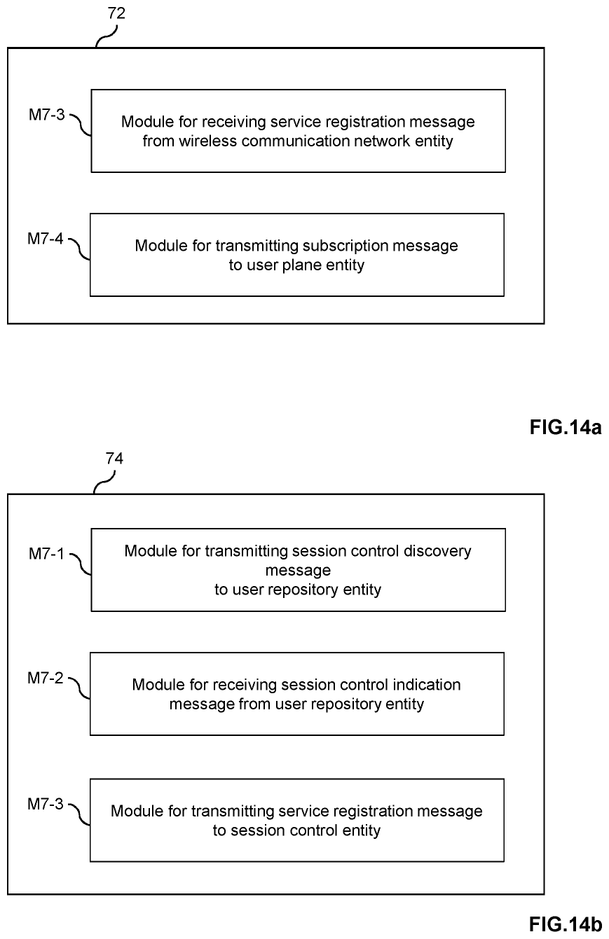

FIG. 14a shows an example session control entity of a wireless communication network;

FIG. 14b shows an example wireless communication network entity of a wireless communication network;

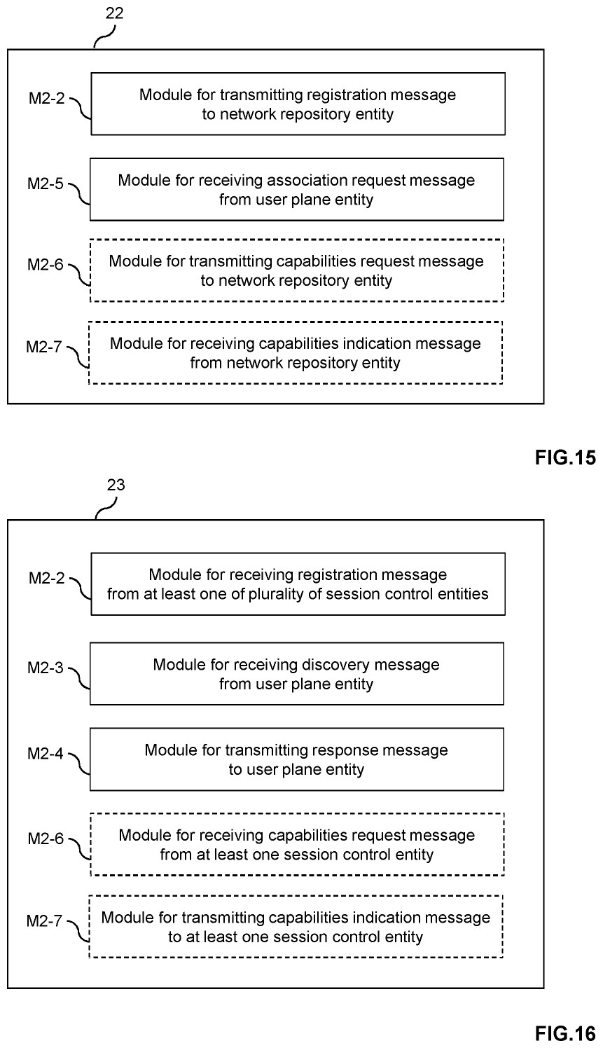

FIG. 15 shows an example session control entity of a wireless communication network;

FIG. 16 shows an example network repository entity of a wireless communication network;

FIG. 17 shows an example session control entity of a wireless communication network;

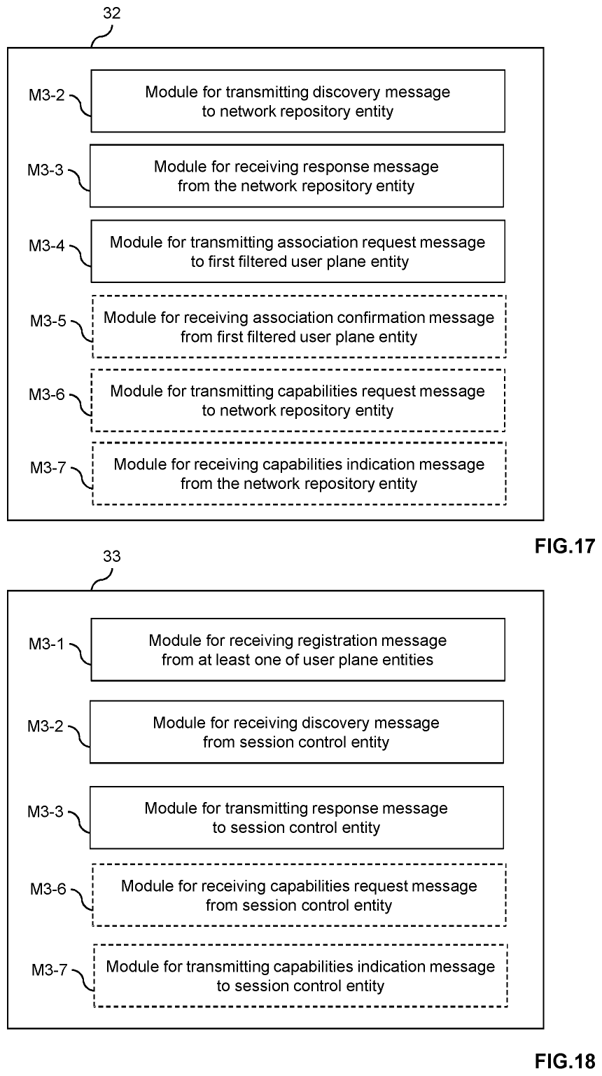

FIG. 18 shows an example network repository entity of a wireless communication network;

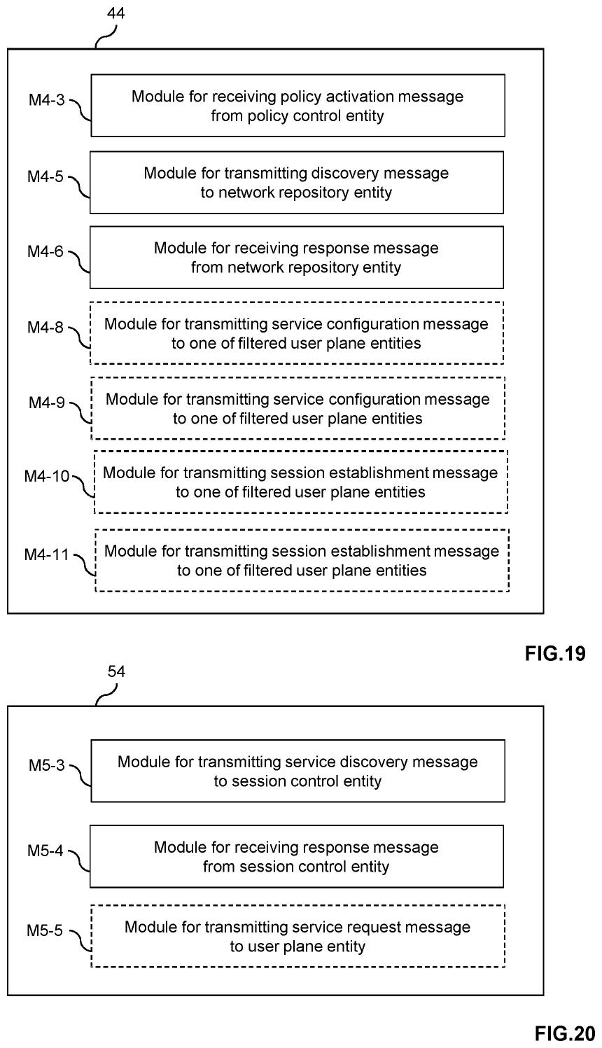

FIG. 19 shows an example session control entity of a wireless communication network;

FIG. 20 shows an example wireless communication network entity of a wireless communication network;

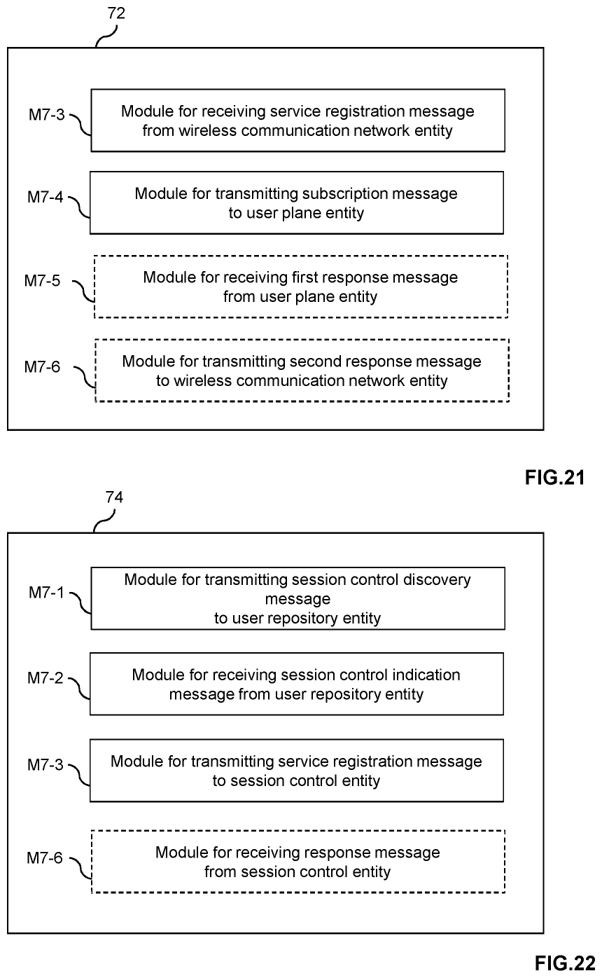

FIG. 21 shows an example session control entity of a wireless communication network;

FIG. 22 shows an example wireless communication network entity of a wireless communication network.

### DETAILED DESCRIPTION OF PREFERRED EMBODIMENTS

In the following, embodiments of the invention will be described in detail with reference to the accompanying drawings. It is to be understood that the following description of embodiments is not to be taken in a limiting sense. The scope of the invention is not intended to be limited by the embodiments described hereinafter or by the drawings, which are to be illustrative only.

The drawings are to be regarded as being schematic representations, and elements illustrated in the drawings are not necessarily shown to scale. Rather, the various elements are represented such that their function and general purpose becomes apparent to a person skilled in the art. Any connection or coupling between functional blocks, devices, components of physical or functional units shown in the drawings and described hereinafter may also be implemented by an indirect connection or coupling. A coupling between components may be established over a wired or wireless connection. Functional blocks may be implemented in hardware, software, firmware, or a combination thereof.

Within the context of the present application, the term “mobile entity” or “user equipment” (UE) 110 refers to a device for instance used by a person (i.e. a user) for his or her personal communication. It can be a telephone type of device, for example a telephone or a Session Initiating Protocol (SIP) or Voice over IP (VoIP) phone, cellular telephone, a mobile station, cordless phone, or a personal digital assistant type of device like laptop, notebook, notepad, tablet equipped with a wireless data connection. The UE may also be associated with non-humans like animals, plants, or machines. A UE may be equipped with a SIM (Subscriber Identity Module) or electronic-SIM comprising unique identities such as IMSI (International Mobile Subscriber Identity), TMSI (Temporary Mobile Subscriber Identity), or GUTI (Globally Unique Temporary UE Identity) associated with the user using the UE. The presence of a SIM within a UE customizes the UE uniquely with a subscription of the user. The wireless communication network is generally any communication network which allows a wireless communications with the user equipment 110. In some embodiments, the wireless communication network can be an LTE network or a 5G NR network.

FIG. 2 shows an example flowchart of a method for operating a user plane entity 21, a session control entity 22 and a network repository entity 23 in a wireless communication network. In particular the method allows the association of a service-based user plane entity 21 with a session control entity 22. In the embodiments of FIG. 2, the association is generally triggered by the user plane entity 21.

The method generally allows the association between the user plane entity 21 and the session control entity 22. The association can then be used to exchange node level messages, including the exchange of Node Capabilities. Moreover, the association can allow initiating node level operation, for instance if a user plane entity 21 is being decommissioned, it may request the session control entity 22 to terminate all its PDU sessions.

FIG. 2 generally relates to a plurality of embodiments, which will be defined in the following description. For a better understanding of how those embodiments can cooperate with each other, a brief general description of all steps illustrated in FIG. 2 will be described first.

At step S2-1 the user plane entity can 21 generally register itself with network repository entity 23. In some embodiments the registration can also include registering the list of supported capabilities of the user plane entity 21. That is, the message sent at step S2-1 can also comprise a list of capabilities of the user plane entity 21, for instance capabilities which can be accessed by other entities in the wireless communication network.

At step S2-2, the session control entity 22 can generally register itself with network repository entity 23. The details of the message sent at step S2-2 will be described in the following. In general, in some embodiments, the message sent at step S2-2 can provide an indication that the session control entity 22 supports an association service, and/or an area indication of the session control entity 22.

Thanks to S2-1 and S2-2, both the user plane entity 21 and the session control entity 22 can thus be registered with the network repository entity 23. Moreover, the information concerning the association service offered by the session control entity 22 can be accessed at the network repository entity 23, for an association between the user plane entity 21 and the session control entity 22.

At step S2-3, the user plane entity 21 can generally send to network repository entity 23 a discovery request allowing the identification of one or more session control entity 22, to which the user plane entity 21 can associate to. The details of the message sent at step S2-3 will be described in the following.

At step S2-4, the network repository entity 23 can generally respond with one or more selected session control entity 22, based on the indications provided at step S2-3. The details of the message sent at step S2-4 will be described in the following.

Thanks to S2-3 and S2-4 the user plane entity 21 can thus be provided with one or more session control entity 22 to which the user plane entity 21 can associate to.

At step S2-5, the user plane entity 21 can generally send a message to a session control entity 22 for carrying out the association. The details of the message sent at step S2-5 will be described in the following.

In general it will be understood that at step S2-5 the user plane entity 21 could also send, together with the association message, a list of its capabilities. This could be particularly advantageous, for instance, if the list of capabilities of the user plane entity 21 was not transmitted to the network repository entity 23 at step S2-1. Moreover, even if the list of capabilities were transmitted to the network repository entity 23 at step S2-1, by transmitting it directly to the session control entity 22 at step S2-5, the session control entity 22 could be provided with the list of capabilities in a faster manner, during the association. Still further, this allows the possibility of sending different capabilities in steps S2-1 and S2-5.

In those embodiments in which the list of capabilities is not sent at step S2-5, optional step S2-6 can generally allow the session control entity 22 to request those capabilities to the network repository entity 23, while optional step S2-7 can generally allow the session control entity 22 to receive the requested list of capabilities from the network repository entity 23. The details of the messages sent at steps S2-6 and S2-7 will be described in the following.

At step S2-8, the session control entity 22 can generally respond acknowledging the association with the user plane entity 21.

Thanks to this approach it is possible for the user plane entity 21 and the session control entity 22 to be associated with each other and for the session control entity 22 to make use of the capabilities, or services, offered by the user plane entity 21, in a manner compatible with a service-based user plane entity 21.

In the following specific embodiments relating to the method described with reference to FIG. 2 will be described in details. It will be understood that, as described in the following, not all steps illustrated in FIG. 2 are necessary for the implementation of every embodiment.

In particular, as illustrated for instance in FIG. 2a, an embodiment of the invention can relate to a method for operating a user plane entity 21 in a wireless communication network. The wireless communication network can comprise the user plane entity 21, a plurality of session control entities 22 and a network repository entity 23.

The plurality of session control entities 22 can be generally configured to handle at least one data packet session in the wireless communication network. The user plane entity 21 can be configured to handle a user plane of the at least one data packet session. The network repository entity 23 can be configured to register the plurality of session control entities 22 and the user plane entity 21.

The method can comprise a step S2-3 of transmitting to the network repository entity 23 a discovery message comprising:
an association request indication, for indicating that the user plane entity 21 can be associated to a session control entity 22,
filtering criteria for filtering the plurality of session control entities 22.

In some embodiments, the filtering criteria can comprise one or more of:
an area of the session control entity 22;
an identifier of the user plane entity 21;
an identifier of a slice of the wireless communication network, for instance, in particular within a 5G implementation, a Network Slice Instance, NSI ID;
a location of the user plane entity 21.

The method can further comprise a step S2-4 of receiving from the network repository entity 23 a response message, in response to the discovery message, comprising:
a list of filtered session control entities 22, filtered based on the filtering criteria.

Moreover, the method can further comprise a step S2-5 of transmitting to a first filtered session control entity 22, of the filtered session control entities 22, an association request message comprising:
an identifier of the user plane entity 21.

Generally, the selection of the first filtered session control entity 22 from the filtered session control entities 22 can be based on different criteria, such as location of the session control entity 22.

Thanks to the method described above, it is thus advantageously possible to operate the user plane entity 21 so as to obtain an association between the user plane entity 21 and one session control entity 22 while operating the user plane entity 21 in a service-based manner.

In some embodiments, the association request message can further comprise:
a list of capabilities of the user plane entity 21.

Thanks to this approach it is advantageously possible to provide the list of capabilities of the user plane entity 21 directly to the associated session control entity 22, thus avoiding the need for the session control entity 22 to retrieve them from the network repository entity 23 and/or allowing different capabilities to be registered by the user plane entity 21 with the associated session control entity 22 and with the network repository entity 23.

Moreover, as illustrated for instance in FIG. 2b, an embodiment of the invention can relate to a method for operating a session control entity 22 in a wireless communication network. The wireless communication network can comprise a user plane entity 21, a plurality of session control entities 22 and a network repository entity 23.

The plurality of session control entities 22 can be generally configured to handle at least one data packet session in the wireless communication network. The user plane entity 21 can be generally configured to handle a user plane of the at least one data packet session. The network repository entity 23 can be generally configured to register the plurality of session control entities 22 and the user plane entity 21.

The method can comprise a step S2-2 of transmitting to the network repository entity 23 a registration message comprising:
an association service indication, for indicating that the session control entity 22 can be associated to a user plane entity 21,
an area indication of the session control entity 22,

The method can further comprise a step S2-5 of receiving from the user plane entity 21 an association request message comprising:
an identifier of the user plane entity 21.

Thanks to this approach, the information registered at step S2-2 can be advantageously used by the wireless communication network to lead to step S2-5, resulting in the association of user plane entity 21 and session control entity 22 even in the absence of a point-to-point interface between those entities.

In some embodiments, the association request message can further comprise
a list of capabilities of the user plane entity 21.

In some embodiments, the method can further comprise a step S2-6 of transmitting to the network repository entity 23 a capabilities request message comprising:
the identifier of the user plane entity 21.

Still further, the method can comprise a step S2-7 of receiving from the network repository entity 23 a capabilities indication message, in response to the capabilities request message, comprising:
a list of capabilities of the user plane entity 21 identified by the identifier.

Thanks to this approach, the list of capabilities of the user plane entity 21 can be advantageously retrieved from the network repository entity 23.

In some embodiments, the step S2-6 of transmitting the capabilities request message, and S2-7 of receiving the capabilities indication message can be carried out if the association request message does not comprise a list of capabilities of the user plane entity 21.

Thanks to this approach, the steps S2-6 and S2-7 can advantageously be avoided if the list of capabilities is already available at the session control entity 22.

Moreover, as illustrated for instance in FIG. 2c, an embodiment of the invention can relate to a method for operating a network repository entity 23 in a wireless communication network. The wireless communication network can comprise a user plane entity 21, a plurality of session control entities 22 and the network repository entity 23.

The plurality of session control entities 22 can be generally configured to handle at least one data packet session in the wireless communication network. The user plane entity 21 can be generally configured to handle a user plane of the at least one data packet session. The network repository entity 23 can be generally configured to register the plurality of session control entities 22 and the user plane entity 21.

The method can comprise a step S2-2 of receiving S2-2 from at least one of the plurality of session control entities 22 a registration message comprising:
an association service indication, for indicating that the at least one session control entity 22 can be associated to a user plane entity 21,
an area indication of the at least one session control entity 22.

In some embodiments this step can be carried out by a plurality, or all, of the plurality of session control entities 22.

The method can further comprise a step S2-3 of receiving from the user plane entity 21 a discovery message comprising:
an association request indication, indicating that the user plane entity 21 can be associated to a session control entities 22,
filtering criteria for filtering the plurality of session control entities 22.

The method can further comprise a step S2-4 of transmitting to the user plane entity 21 a response message, in response to the discovery message, comprising:
a list of filtered session control entities 22, filtered based on the filtering criteria.

It will be clear that the network repository entity 23 can be configured to filter, from those session control entity 22 which have registered with the network repository entity 23, the session control entities 22 which match the filtering criteria provided by the user plane entity 21.

In some embodiments, the method can further comprise a step S2-6 of receiving from the at least one session control entity 22 a capabilities request message comprising:
an identifier of the user plane entity 21.

The method can further comprise a step S2-7 of transmitting to the at least one session control entity 22 a capabilities indication message, in response to the capabilities request message, comprising:
a list of capabilities of the user plane entity 21 identified by the identifier.

In some embodiments, specifically in an implementation of the embodiments described with reference to FIG. 2 in a 5G network, one or more of steps S2-1 to S2-8 could be formally formulated as:

S2-1: Nnrf_NFMgmt NFRegister {capabilities}

S2-2: Nnrf_NFMgmt NFRegister {Association service, SMF area}

S2-3. Nnrf_NFMgmt NFDiscovery {NFtype=SMF, Association service, filter criteria: SMF area

/UPF-ID/NSI-ID/UPF Location}

S2-4. Response (list of SMF addresses)

S2-5. Nsmf_Association {UPF-ID, (opt) capabilities}

S2-6. Nnrf_AccessToken Get {UPF-ID, capabilities}

S2-7. Response (capabilities)

S2-8. Response

Thanks to the methods described above it is possible to operate various network entities so at to allow the association between a user plane entity 21 and a session control entity 22, in particular allowing triggering of the association by the user plane entity 21. As an alternative, it is also possible to allow such association to be triggered by the session control entity 22, as will be explained more in detail with reference to FIG. 3.

FIG. 3 shows an example flowchart of a method for operating a user plane entity 31, a session control entity 32 and a network repository entity 33 in a wireless communication network. In particular the method allows the association of a service-based user plane entity 31 with a session control entity 32. In the embodiments of FIG. 3, the association is generally triggered by the session control entity 32.

The method generally allows the association between the user plane entity 31 and the session control entity 32. The association can then be used to exchange node level messages, including the exchange of Node Capabilities. Moreover, the association can allow initiating node level operation, for instance if a user plane entity 31 is being decommissioned, it may request the session control entity 2 to terminate all its PDU sessions.

FIG. 3 generally relates to a plurality of embodiments, which will be defined in the following description. For a better understanding of how those embodiments can cooperate with each other, a brief general description of all steps illustrated in FIG. 3 will be described first.

At step S3-1, the user plane entity 31 can generally register itself with network repository entity 33. The details of the message sent at step S3-1 will be described in the following. In general, in some embodiments, the message sent at step S3-1 can comprise a list of capabilities of the user plane entity 31, for instance capabilities which can be accessed by other entities in the wireless communication network. Moreover, the message sent at step S3-1 can also provide an indication that the user plane entity 31 supports an association service. Furthermore, the message sent at step S3-1 can also comprise an area indication of a session control entity 32 to which the user plane entity 31 belongs and/or other filtering criteria.

At step S3-2, the session control entity 32 can generally send to network repository entity 33 a discovery request allowing the identification of one or more user plane entity 31, to which the session control entity 32 can associate to. The details of the message sent at step S3-2 will be described in the following.

At step S3-3, the network repository entity 33 can generally respond with one or more selected user plane entity 31, based on the indications provided at step S3-2. The details of the message sent at step S3-3 will be described in the following.

At step S3-4, the session control entity 32 can generally send a message to a user plane entity 31 for carrying out the association. The details of the message sent at step S3-4 will be described in the following.

At step S3-5, the user plane entity 31 can generally respond with a message acknowledging the association with the session control entity 32. The details of the message sent at step S3-5 will be described in the following. In some embodiments, the message sent at step S3-5 could also comprise an identifier of the user plane entity 31.

In general it will be understood that at step S3-5 the user plane entity 31 could also send, together with the association confirmation message, a list of its capabilities. This could be particularly advantageous, for instance, if the list of capabilities of the user plane entity 31 was not transmitted to the network repository entity 33 at step S3-1. Moreover, even if the list of capabilities were transmitted to the network repository entity 33 at step S3-1, by transmitting it directly to the session control entity 32 at step S3-5, the session control entity 32 could be provided with the list of capabilities in a faster manner, during the confirmation of the association. Still further, this allows the possibility of sending different capabilities in steps S3-1 and S3-5.

In those embodiments in which the list of capabilities is not sent at step S3-5, optional step S3-6 can generally allow the session control entity 32 to request those capabilities to the network repository entity 33, while optional step S3-7 can generally allow the session control entity 32 to receive the requested list of capabilities from the network repository entity 33. The details of the messages sent at steps S3-6 and S3-7 will be described in the following.

Thanks to this approach it is possible for the user plane entity 31 and the session control entity 32 to be associated with each other and for the session control entity 32 to make use of the capabilities, or services, offered by the user plane entity 31, in a manner compatible with a service-based user plane entity 31.

In the following specific embodiments relating to the method described with reference to FIG. 3 will be described in details. It will be understood that, as described in the following, not all steps illustrated in FIG. 3 are necessary for the implementation of every embodiment.

In particular, as illustrated for instance in FIG. 3a, an embodiment of the invention can relate to a method for operating a user plane entity 31 in a wireless communication network, the wireless communication network comprising a plurality of user plane entities 31, a session control entity 32 and a network repository entity 33.

The session control entity 32 can be generally configured to handle at least one data packet session in the wireless communication network. The plurality of user plane entities 31 can be generally configured to handle a user plane of the at least one data packet session. The network repository entity 33 can be generally configured to register the session control entity 32 and the plurality of user plane entities 31.

The method can comprise a step S3-1 of transmitting to the network repository entity 33 a registration message comprising:
an association service indication, for indicating that the user plane entity 31 can be associated to a session control entity 32.

In some embodiments, the registration message can further comprise:
a list of capabilities of the user plane entity 31, for instance capabilities which can be accessed by other entities in the wireless communication network, and/or
an area indication of a session control entity 32 to which the user plane entity 31 belongs,
and/or other filtering criteria.

The method can further comprise a step S3-4 of receiving from the session control entity 32 an association request message comprising:
an identifier of the session control entity 32.

The method can further comprise a step S3-5 of transmitting to the session control entity 32 an association confirmation message, in response to the association request message.

Thanks to this approach, it is possible to identify the user plane entity 31 to which the session control entity 32 is to be associated to. In particular, the information registered at step S3-1 can be advantageously used by the wireless communication network to lead to step S3-4, resulting in the association of user plane entity 31 and session control entity 32 even in the absence of a point-to-point interface between those entities.

In some embodiments, the association confirmation message can further comprise:
a list of capabilities of the user plane entity 31.

Thanks to this approach it is advantageously possible to provide the list of capabilities of the user plane entity 31 directly to the associated session control entity 32, thus avoiding the need for the session control entity 32 to retrieve them from the network repository entity 33 and/or allowing different capabilities to be registered by the user plane entity 31 with the associated session control entity 32 and with the network repository entity 33.

Moreover, as illustrated for instance in FIG. 3b, an embodiment of the invention can relate to a method for operating a session control entity 32 in a wireless communication network. The wireless communication network can comprise a plurality of user plane entities 31, the session control entity 32 and a network repository entity 33.

The session control entity 32 can be generally configured to handle at least one data packet session in the wireless communication network. The plurality of user plane entities 31 can be generally configured to handle a user plane of the at least one data packet session. The network repository entity 33 can be generally configured to register the session control entity 32 and the plurality of user plane entities 31.

The method can comprise a step S3-2 of transmitting to the network repository entity 33 a discovery message comprising:
an association request indication, for indicating that the session control entity 32 can be associated to a user plane entity 31,
filtering criteria for filtering the plurality of user plane entities 31.

In some embodiments, the filtering criteria can comprise one or more of:
an area of the session control entity 32;
one or more capabilities of the user plane entity 31;
an identifier of a slice of the wireless communication network, for instance, in particular within a 5G implementation, a Network Slice Instance, NSI ID;
a location of the user plane entity 21.

The method can further comprise a step S3-3 of receiving from the network repository entity 33 a response message, in response to the discovery message, comprising:
a list of filtered user plane entities 31, filtered based on the filtering criteria.

In some embodiments, the list of filtered user plane entities 31 can comprise, for each user plane entity 31, an identifier of the user plane entity 31 and/or an address of the user plane entity 31.

The method can further comprise a step S3-4 of transmitting to a first filtered user plane entity 31, of the filtered user plane entities 31, an association request message comprising:
an identifier of the session control entity 32.

Generally, the selection of the first filtered user plane entity 31 from the filtered user plane entities 31 can be based on different criteria, such as location of the session control entity 32.

Thanks to the method described above, it is thus advantageously possible to operate the session control entity 32 so as to obtain an association between the user plane entity 31 and one session control entity 32 while operating the user plane entity 31 in a service-based manner.

In some embodiments, the method can further comprise a step S3-5 of receiving from the first filtered user plane entity 31 an association confirmation message, in response to the association request message.

In some embodiments, the association confirmation message can further comprise:
a list of capabilities of the first filtered user plane entity (31).

In some embodiments, the method can further comprise a step S3-6 of transmitting to the network repository entity 33 a capabilities request message comprising:
the identifier of the first filtered user plane entity 31.

Furthermore, the method can further comprise a step S3-7 of receiving from the network repository entity 33 a capabilities indication message, in response to the capabilities request message, comprising:
a list of capabilities of the first filtered user plane entity 31 identified by the identifier.

Thanks to this approach, the list of capabilities of the user plane entity 31 can be advantageously retrieved from the network repository entity 33.

In some embodiments, the step 3-6 of transmitting the capabilities request message, and S3-7 of receiving the capabilities indication message can be carried out if the association confirmation message does not comprise a list of capabilities of the user plane entity 31.

Thanks to this approach, the steps S3-6 and S3-7 can advantageously be avoided if the list of capabilities is already available at the session control entity 32.

Moreover, as illustrated for instance in FIG. 3c, an embodiment of the invention can relate to a method for operating a network repository entity 33 in a wireless communication network. The wireless communication network can comprise a plurality of user plane entities 31, a session control entity 32 and the network repository entity 33.

The session control entity 32 can be generally configured to handle at least one data packet session in the wireless communication network. The plurality of user plane entities 31 can be generally configured to handle a user plane of the at least one data packet session. The network repository entity 33 can be generally configured to register the session control entity 32 and the plurality of user plane entities 31.

The method can comprise a step S3-1 of receiving S3-1 from at least one of the user plane entities 31 a registration message comprising:
an association service indication, for indicating that the at least one user plane entity 31 can be associated to a session control entity 32.

In some embodiments, the registration message can further comprise:
a list of capabilities of the user plane entity 31, for instance capabilities which can be accessed by other entities in the wireless communication network, and/or
an area indication of a session control entity 32 to which the user plane entity 31 belongs,
and/or other filtering criteria.

The method can further comprise a step S3-2 of receiving from the session control entity 32 a discovery message comprising:
an association request indication, for indicating that the session control entity 31 can be associated to a user plane entity 32,
filtering criteria for filtering the plurality of user plane entities 31.

The method can further comprise a step S3-3 of transmitting to the session control entity 32 a response message, in response to the discovery message, comprising:
a list of filtered user plane entities 31, filtered based on the filtering criteria.

It will be clear that the network repository entity 33 can be configured to filter, from those user plane entities 31 which have registered with the network repository entity 33, the user plane entities 31 which match the filtering criteria provided by the session control entity 32.

In some embodiments, the method can further comprise a step S3-6 of receiving S3-6 from the session control entity 32 a capabilities request message comprising:
an identifier of a user plane entity 31.

The method can further comprise a step S3-7 of transmitting to the session control entity 32 a capabilities indication message, in response to the capabilities request message, comprising:
a list of capabilities of the user plane entity 31 identified by the identifier.

In some embodiments, specifically in an implementation of the embodiments described with reference to FIG. 3 in a 5G network, one or more of steps S3-1 to S3-7 could be formally formulated as:

S3-1. Nnrf_NFMgmt NFRegister {capabilities, Association service, SMF area / . . . }

S3-2. Nnrf_NFMgmt NFDiscovery {NFtype=UPF, Association service, filter criteria: SMF area

/UPF capabilities, NSI ID, Location, etc.}

S3-3. Response (list of UPF-ID and/or UPF address)

S3-4. Nupf_Association {SMF-ID}

S3-5. Response (opt capabilities)

S3-6. Nnrf_AccessToken Get {UPF-ID, capabilities}

S3-7. Response (capabilities)

It will be clear to those skilled in the art that other service operations handled by the association service(s) and targeting all or a group of the PDU sessions handled by the NF, may be defined, in particular in addition to the NF capabilities discovery in the embodiments described above with reference to FIGS. 2 and 3.

FIG. 4 shows an example flowchart of a method for operating a mobility management entity 41, user plane entities 42 and 43, a session control entity 44, a policy control entity 45 and a network repository entity 46 in a wireless communication network. In particular the method relates to a process taking place at PDU session establishment with service-based user plane entities 42, 43.

The method generally allows the one or more session control entity 44, selected by the mobility management entity 41 to select the specific user plane entity 42,43 and the respective services to be appointed for the user plane packet processing of the specific PDU session.

FIG. 4 generally relates to a plurality of embodiments, which will be defined in the following description. For a better understanding of how those embodiments can cooperate with each other, a brief general description of all steps illustrated in FIG. 4 will be described first.

At step S4-1 the mobility management entity 41 generally initiates a session establishment by sending a session establishment request message to the session control entity 44. Generally, the session establishment request message indicates a request for establishing a PDU session. In some embodiments, the session establishment request message comprises one or more of an identifier of a user of the wireless communication network, in particular of a UE 110, and/or a location of a UE, preferably of the UE corresponding to the user identifier.

At steps S4-2 and S4-3, the session control entity retrieves policy rules, such as Policy and Charging Control, PCC, corresponding to the UE of the session establishment request message. This is achieved by sending, at step S4-2 a policy request message to the policy control entity 45. In some embodiments, the policy request message can comprise the user identifier of the session establishment request message. At step S4-3 the policy control entity 45 responds with a policy activation message, which will be described in the following. It will be understood that the policy activation message relates to the policy rules to be activated with respect to the policy request message, that is, for instance, with respect to the user identifier of the session establishment request message.

At step S4-4, the session control entity 44 evaluates whether traffic breakout is needed. That is, it is evaluated if one or more user plane entities 42, 43 are needed to implement the policy rules. Depending on the results of the evaluation, the one or more user plane entities 42, 43 might also be identified. In some embodiments, the location of each of the one or more user plane entities 42, 43 could be determined. In the embodiment illustrates in FIG. 4, an example is provided in which the result of step S4-4 consists of two user plane entities 42, 43 and the following description will be based on this assumption. It will however be clear that the invention is not limited to this specific implementation and that more or less than two user plane entities 42, 43 could be implemented, depending on the result of the step S4-4.

At steps S4-5 and S4-6, the session control entity 44 generally retrieves further details concerning the one or more user plane entities 42, 43 determined at step S4-4. This is achieved, in particular by sending, at step S4-5, a discovery message to the network repository entity 46 and by receiving, at step S4-6, a response message from the network repository entity 46. The details of those messages are discussed in the following.

At step S4-7, the session control entity 44 generally selects one or more of the user plane entities 42, 43 for the PDU session and/or the one or more services to be configured, and/or chained, in each user plane entity 42, 43. In some embodiments, the selection can be done based on one or more of the associated user plane entities, services and location of the user plane entity. It will be clear to those skilled in the art that the specific algorithms used for the selection are implementation specific.

Steps S4-8 and S4-9, which are optional, generally allow the session control entity 44 to configure one or more services in the one or more user plane entities 42, 43 based on the results of step S4-7. In particular, in some embodiments, the session control entity 44 can invoke a generic configuration service of the user plane entity 42, 43, as generally exposed by the service-based user plane entity 42, 43 in the wireless communication network. Alternatively, or in addition, the session control entity 44 can invoke and activation and/or configuration function of the specific service required on the user plane entity 42, 43. That is, in the first case, reference is made to a function of the user plane entity 42, 43 which allows the configuration of a generic service thereof, and the service can be provided as an object of the request, together with the activation/configuration of the service. In the second case, reference is made to a configuration function of the user plane entity 42, 43 specific to the service which needs to be configured, so that only the activation/configuration needs to be provided as an object of the request.

Steps S4-8 and S4-9 can be implemented for one or more of the user plane entities 42, 43 identified in step S4-7. It will be clear that steps S4-8 and S4-9 could be optional since, in some cases, it is possible that the desired services at the user plane entity 42, 43 are already activated and configured as necessary. In preferred embodiments, steps S4-8, S4-9 are implemented for each of the user plane entities 42, 43 determined at step S4-7.

At steps S4-10, S4-11, the session control entity 44 generally establish a packet data session, for instance a PDU session, at one or more of the user plane entities 42, 43 determined at step S4-7. Details of the session establishment message sent to the respective user plane entity are described in the following. In preferred embodiments, steps S4-10, S4-11 are implemented for each of the user plane entities 42, 43 determined at step S4-7.

At steps S4-12, S4-13, the user plane entities 42, 43 generally confirm receipt of the respective session establishment messages and/or implementation of the session establishment.

At step S4-14 the session establishment procedure is completed. In particular, in some embodiments, among the various steps which may be taken to complete the session establishment, the session control entity 44 can transmit a PDU session establishment response to the mobility management entity 41.

In particular, as illustrated for instance in FIG. 4a, an embodiment of the invention can relate to a method for operating a session control entity 44 in a wireless communication network, the wireless communication network comprising a plurality of user plane entities 42, 43, the session control entity 44, a policy control entity 45, and a network repository entity 46. In some further embodiment, the wireless communication network can further comprise a mobility management entity 41.

The session control entity 44 can be generally configured to handle at least one data packet session in the wireless communication network. The plurality of user plane entities 42, 43 can be generally configured to handle a user plane of the at least one data packet session. The policy control entity 45 can be generally configured to handle a policy plane of the at least one data packet session. The network repository entity 46 can be generally configured to register the plurality of session control entities 44 and the user plane entity 42. In some embodiments, the network repository entity 46 can be further generally configured to register the mobility management entity 41 and/or the policy control entity 45. The mobility management entity 41 can be generally configured to manage the mobility of one or more UE 110 through the wireless communication network.

The method can comprise a step S4-3 of receiving from the policy control entity 45 a policy activation message comprising:
a list of services to be activated in the plurality of user plane entities 42, 43.

In some embodiments, the list of services may be specific for a given user identifier previously provided to the policy control entity 45. Moreover, in some embodiments, the services may comprise one or more of
services to activate in user plane entity 42, 43 such as, for instance, Firewalling, QoS, DDoS, detection, etc.

In some embodiments, the policy activation message can further comprise one or more of:
an identifier of an application, or type of traffic, to which the policies apply,
traffic steering information and/or routing profiles to apply for the given user identifier.

The method can further comprise a step S4-5 of transmitting to the network repository entity 46 a discovery message comprising:
filtering criteria for filtering the plurality of user plane entities 42, 43.

In some embodiments, the filtering criteria may comprise one or more of:
an area of a session control entity 44;
one or more services of a user plane entity 42, 43;
an identifier of a slice of the wireless communication network, for instance, in particular within a 5G implementation, a Network Slice Instance, NSI ID;
location of the one or more user plane entities 42, 43, preferably as determined at step S4-4.

In some embodiments, discovery message may further comprise:
an indication that the discovery message relates to the discovery of one or more user plane entities 42, 43

The method can moreover comprise a step S4-6 of receiving from the network repository entity 46 a response message, in response to the discovery message, comprising:
a list of filtered user plane entities 42, 43, filtered based on the filtering criteria.

In some embodiments, the response message may further comprise, for each of the filtered user plane entities 42, 43, one or more of:
an identifier of the user plane entity 42, 43;
services, or capabilities, offered by the user plane entity 42, 43;
a location of the user plane entity 42, 43, preferably if this was not included in the filtering criteria.

In some embodiments, the filtering criteria can comprise:
the list of services to be activated in the plurality of user plane entities 42, 43.

In some embodiments, the method can further comprise the step of:
transmitting S4-8, 4-9 to one of the filtered user plane entities 42, 43 a service configuration message for activating and/or configuring at least one of the list of services to be activated.

In some embodiments, the method can further comprise the step of:
transmitting S4-10, 4-11 to one of the filtered user plane entities 42, 43 a session establishment message for configuring one of the list of services to be activated.

In general, the session control entity 44 can control the packet processing in the user plane entities 42, 43 by establishing, modifying or deleting, packet sessions, such as Packet

Forwarding Control Protocol, PFCP, sessions. It will be clear that such packet sessions may correspond to an individual PDU session or a standalone PFCP session, not tied to any PDU session. Moreover, the session control entity 44 can control the packet processing in the user plane entities 42, 43 by provisioning, for instance by adding, modifying or deleting, parameters of the respective sessions.

Those parameters, particularly in the context of a 5G implementation, may comprise in particular Packet Detection Rules, PDRs, comprising a Packet Detection Information, PDI, specifying traffic filters or signatures against which incoming packets are matched. Each PDR can be associated to one or more of the following rules, providing the set of instructions to apply to packets matching the PDI:
Forwarding Action Rule, FAR, which contains instructions related to the processing of the packets, in particular one or more of forward, duplicate, drop or buffer the packet with or without notifying the control plane function about the arrival of a DL packet;
QoS Enforcement Rule, QER, which contains instructions related to the QoS enforcement of the traffic;
Usage Reporting Rule, URR, which contains instructions related to traffic measurement and reporting;
Buffering Action Rule, BAR, which contains the buffering rules to apply to the matching packets.

In some embodiments, specifically in an implementation of the embodiments described with reference to FIG. 4 in a 5G network, one or more of steps S4-1 to S4-14 could be formally formulated as:

S4-1: PDU session establishment request (User-ID, UE location)

S4-2: Get PCC rules (User-ID)

S4-3: PCC rule {App-ID, List (UP services), Traffic steering info/routing profile}

S4-4: Based on the traffic steering info SMF decides if traffic breakout (several UPFs) is needed and the locations the UPFs should be selected.

S4-5: Nnrf_NFDiscovery (NFType=UPF, location, list (UP services))

S4-6: Response (list [UPF-ID, services, location])

S4-7: Based on the associated UPFs, UPF services and location, SMF selects the UPF(s) and selects the services chained per UPF.

S4-8, S4-9: (Optional) Nupf_ConfigService {activation/config} and/or (Optional) Nupf_X {activation/config}, where X is the service to be activated/configured

S4-10, S4-11: Nupf_SM {PDR (App-ID), FAR [ordered-list(service-IDs)]}

S4-12, S4-13: Response

S4-14: 11. PDU session establishment completion

Thanks to the method described above it is possible to establish a packed data session in the presence of one or more service-based user plane entities 42, 43.

If other network functions, or network entities, need to interact with the one or more service-based user plane entity handling the user plane of a specific packet session, those network entities generally need to obtain the address or identifier of the one or more user plane entities. In the following, various embodiments will be described which enable resolving the address and/or identifier of the one or more user plane entities and/or enable exchanging messages with the one or more user plane entities as well as subscription/notification to one or more service provided by the one or more user plane entities.

In the embodiments above, an association service and a session management service have been described for a service-based user plane entity. Those services might be implemented as two independent services. Alternatively, or in addition, the same functionality could be provided as a single service. In this case, the association and the session management functionality could be implemented as independent operations of the same service, instead of independent services.

FIG. 5 shows an example flowchart of a method for operating a user plane entity 51, a session control entity 52, a user repository entity 53, and a wireless communication network entity 54 in a wireless communication network. In particular the method allows a generic wireless communication network entity 54 to access services provided by the service-based user plane entity 51. In the embodiments of FIG. 5, the discovery of the services of the user plane entity 51 is generally obtained through the session control entity 52.

FIG. 5 generally relates to a plurality of embodiments, which will be defined in the following description. For a better understanding of how those embodiments can cooperate with each other, a brief general description of all steps illustrated in FIG. 5 will be described first.

At step S5-1, the wireless communication network entity 54 generally requires the address of a session control entity 52 associated to a given user of the wireless communication network, for instance an UE 110. In some embodiments this may be achieved by sending to the user repository entity 53 a user query message. In some embodiments, the user query message can comprise a user identifier, allowing identification of a given user in the wireless communication network.

At step S5-2, the user repository entity 53 generally responds to the wireless communication network entity 54 with an address of the session control entity 52 allocated to the given user.

At step S5-3, the wireless communication network entity 54 generally requests to the session control entity 52, by using the address obtained at step S5-2, an address of a user plane entity 51. In some embodiments, the user plane entity 51 may be the one associated to the given user. Moreover, in some embodiments, the user plane entity 51 may be the one associated to a given service, or capability. Details of the message sent at step S5-3 will be discussed in the following.

At step S5-4, the session control entity 52 generally responds with the address of the user plane entity 51 identified based on the step S5-3.

At step S5-5, by using the address obtained at step S5-4, the wireless communication network entity 54 generally requests and/or subscribes to one or more services from user plane entity 51.

At step S5-6 the user plane entity 51 executes the requested service operation and provides the response to the wireless communication network entity 54.

In the following specific embodiments relating to the method described with reference to FIG. 5 will be described in details. It will be understood that, as described in the following, not all steps illustrated in FIG. 5 are necessary for the implementation of every embodiment.

In particular, as illustrated for instance in FIG. 5a, an embodiment of the invention can relate to a method for operating a session control entity 52 in a wireless communication network, the wireless communication network comprising a user plane entity 51, the session control entity 52, a user repository entity 53, and a wireless communication network entity 54.

The session control entity 52 can be generally configured to handle at least one data packet session in the wireless communication network. The user plane entity 51 can be generally configured to handle a user plane of the at least one data packet session. The user repository entity 53 can be generally configured to register subscriber information for users of the wireless communication network. The wireless communication network entity 54 can be generally an entity of the wireless communication network accessing services of at least the user plane entity 51.

The method can comprise a step S5-3 of receiving from the wireless communication network entity 54 a service discovery message comprising:
a service indication, for indicating a service provided by the user plane entity 51,
an identifier of a user of the wireless communication network.

The method can further comprise a step S5-4 of transmitting to the wireless communication network entity 54 a response message, in response to the service discovery message, comprising:
an address of the user plane entity 51.

It will be clear that the address of the user plane entity 51 can be obtained by the session control entity 52 by filtering the available user plane entities 51 with respect to the user and service indicated in the service discovery message.

Moreover, as illustrated for instance in FIG. 5b, an embodiment of the invention can relate to a method for operating a wireless communication network entity 54 in a wireless communication network, the wireless communication network comprising a user plane entity 51, a session control entity 52, a user repository entity 53, and the wireless communication network entity 54.

The session control entity 52 can be generally configured to handle at least one data packet session in the wireless communication network. The user plane entity 51 can be generally configured to handle a user plane of the at least one data packet session. The user repository entity 53 can be generally configured to register subscriber information for users of the wireless communication network. The wireless communication network entity 54 can be generally an entity of the wireless communication network accessing services of at least the user plane entity 51.

The method can comprise a step S5-3 of transmitting to the session control entity 52 a service discovery message comprising:
a service indication, for indicating a service provided by the user plane entity 51,
an identifier of a user of the wireless communication network.

The method can further comprise a step S5-4 of receiving from the session control entity 52 a response message, in response to the service discovery message, comprising:
an address of the user plane entity 51.

Thanks to the methods described above, it is thus advantageously possible to identify a user plane entity 51 through a session control entity 52 while operating the user plane entity 51 in a service-based manner.

In some embodiments. the method can further comprise a step S5-5 of transmitting to the user plane entity 51 a service request message comprising:
the service indication,
the identifier of the user of the wireless communication network.

In this manner it is possible for the wireless communication network entity 54 to subscribe to the intended service for the intended user.

In some embodiments, specifically in an implementation of the embodiments described with reference to FIG. 5 in a 5G network, one or more of steps S5-1 to S5-6 could be formally formulated as:

S5-1: Nudm_Get SMF (User-ID)

S5-2: SMF address

S5-3: Nsmf_Get Service (User-ID, service-ID)

S5-4: Service address

S5-5: Nupf_Service Request/Subscribe

S5-6: Response

FIG. 6 shows an example flowchart of a method for operating a user plane entity 61, a session control entity 62, a user repository entity 63, and a wireless communication network entity 64 in a wireless communication network. In particular the method allows a generic wireless communication network entity 64 to access services provided by the service-based user plane entity 61. In the embodiments of FIG. 6, the discovery of the services of the user plane entity 61 is generally obtained through the user repository entity 63.

FIG. 6 generally relates to a plurality of embodiments, which will be defined in the following description. For a better understanding of how those embodiments can cooperate with each other, a brief general description of all steps illustrated in FIG. 6 will be described first.

At step S6-1, the session control entity 62 generally selects a service provided by the user plane entity 61 (step 7 in FIG. 3). In some embodiments this could be done in a manner similar to what previously described for step S4-7. In some embodiments, the selection can be based on a user identifier and/or on a given service for a given user identifier.

At step S6-2, the session control entity 62 generally registers in the user repository entity 63 the service selected at step S6-1. In some embodiments this can also comprise sending a user identifier and a service indication. Details of the message sent at step S6-2 will be discussed in the following.

At step 6-3 the user repository entity 63 generally acknowledges the registration.

At step S6-4, the wireless communication network entity 64 generally requests to the user repository entity 63 an address of a user plane entity 61. In some embodiments, the user plane entity 61 may be the one associated to a given user. Moreover, in some embodiments, the user plane entity 61 may be the one associated to a given service, or capability. Details of the message sent at step S6-4 will be discussed in the following.

At step S6-5, the session control entity 62 generally responds with the address of the user plane entity 61, in some embodiments the address can be identified based on the registration of step S6-2.

At step S6-6, by using the address obtained at step S6-5, the wireless communication network entity 64 generally requests and/or subscribes to one or more services from user plane entity 61.

At step S6-7 the user plane entity 61 executes the requested service operation and provides the response to the wireless communication network entity 64.

In the following specific embodiments relating to the method described with reference to FIG. 6 will be described in details. It will be understood that, as described in the following, not all steps illustrated in FIG. 6 are necessary for the implementation of every embodiment.

In particular, as illustrated for instance in FIG. 6a, an embodiment of the invention can relate to a method for operating a user repository entity 63 in a wireless communication network, the wireless communication network comprising a user plane entity 61, a session control entity 62, the user repository entity 63, and a wireless communication network entity 64.

The session control entity 62 can be generally configured to handle at least one data packet session in the wireless communication network. The user plane entity 61 can be generally configured to handle a user plane of the at least one data packet session. The user repository entity 63 can be generally configured to register subscriber information for users of the wireless communication network. The wireless communication network entity 64 can be generally an entity of the wireless communication network accessing services of at least the user plane entity 61.

The method can comprise a step S6-2 of receiving from the session control entity 62 a service registration message comprising:
a service indication, for indicating a service provided by the user plane entity 61,
an identifier of a user of the wireless communication network.

This allows to register the service in association with the given user. The method can further comprise a step S6-4 of receiving from the wireless communication network entity 64 a service discovery message comprising:
the identifier of the user of the wireless communication network,

Thanks to this it is possible to retrieve the service associated to the user. The information on the service received at step S6-2 might also comprise the address of the user plane entity 61 providing the service. Alternatively or in addition, it might be possible for the user repository entity 63 to retrieve the address of the user plane entity 61 providing a given service based on the characteristics of the service alone.

The method can further comprise a step S6-5 of transmitting to the wireless communication network entity 64 a response message, in response to the service discovery message, comprising:
an address of the user plane entity 61.

In this manner it is possible for the wireless communication network entity 64 to obtain the address of the user plane entity 61 operating in a service-based manner, thanks to the registration of the service in the user repository entity 63.

Additionally, as illustrated for instance in FIG. 6b, an embodiment of the invention can relate to a method for operating a session control entity 62 in a wireless communication network, the wireless communication network comprising a user plane entity 61, the session control entity 62, a user repository entity 63, and a wireless communication network entity 64,

The session control entity 62 can be generally configured to handle at least one data packet session in the wireless communication network. The user plane entity 61 can be generally configured to handle a user plane of the at least one data packet session. The user repository entity 63 can be generally configured to register subscriber information for users of the wireless communication network. The wireless communication network entity 64 can be generally an entity of the wireless communication network accessing services of at least the user plane entity 61.

The method can comprise a step S6-1 of selecting services provided by the user plane entity 61. The method can further comprise a step S6-2 of transmitting to the user repository entity 63 a service registration message comprising:
a service indication, for indicating a service provided by the user plane entity 61,
an identifier of a user of the wireless communication network.

Further, as illustrated for instance in FIG. 6c, an embodiment of the invention can relate to a method for operating a wireless communication network entity 64 in a wireless communication network, the wireless communication network comprising a user plane entity 61, a session control entity 62, a user repository entity 63, and the wireless communication network entity 64.

The session control entity 62 can be generally configured to handle at least one data packet session in the wireless communication network. The user plane entity 61 can be generally configured to handle a user plane of the at least one data packet session. The user repository entity 63 can be generally configured to register subscriber information for users of the wireless communication network. The wireless communication network entity 64 can be generally an entity of the wireless communication network accessing services of at least the user plane entity 61.

The method can comprise a step S6-4 of transmitting S6-4 to the user repository entity 63 a service discovery message comprising
an identifier of a user of the wireless communication network,

The method can further comprise a step S6-5 of receiving from the user repository entity 63 a response message, in response to the service discovery message, comprising:
an address of the user plane entity 61.

In this manner it is possible for the wireless communication network entity 64 to subscribe to the intended service for the intended user.

In some embodiments, specifically in an implementation of the embodiments described with reference to FIG. 6 in a 5G network, one or more of steps S6-1 to S6-7 could be formally formulated as:

S6-1: Service selection

S6-2: Nudm_Register Service (User-ID, Service-ID)

S6-3: Response

S6-4: Nudm_Get UPF service (User-ID)

S6-5: Service address

S6-6: Nupf_Service Request

S6-7: Response

FIG. 7 shows an example flowchart of a method for operating a user plane entity 71, a session control entity 72, a user repository entity 73, and a wireless communication network entity 74 in a wireless communication network. In particular the method allows a generic wireless communication network entity 74 to access services provided by the service-based user plane entity 71. In the embodiments of FIG. 7, the discovery of the services of the user plane entity 71 is generally obtained through the user repository entity 73.

FIG. 7 generally relates to a plurality of embodiments, which will be defined in the following description. For a better understanding of how those embodiments can cooperate with each other, a brief general description of all steps illustrated in FIG. 7 will be described first.

At step S7-1, the wireless communication network entity 74 generally requires the address of a session control entity 72 associated to a given user of the wireless communication network, for instance an UE 110. In some embodiments this may be achieved by sending to the user repository entity 73 a user query message. In some embodiments, the user query message can comprise a user identifier, allowing identification of a given user in the wireless communication network.

At step S7-2, the user repository entity 73 generally responds to the wireless communication network entity 74 with an address of the session control entity 72 allocated to the given user.

At step S7-3, the wireless communication network entity 74 generally requests to the session control entity 72, by using the address obtained at step S7-2 to subscribe the wireless communication network entity 74 to a service provided by user plane entity 71. In some embodiments, the user plane entity 71 may be the one associated to the given user. Moreover, in some embodiments, the user plane entity 71 may be the one associated to a given service, or capability. Details of the message sent at step S7-3 will be discussed in the following.

At steps S7-4 and S7-5 the session control entity 72 generally subscribes the service provided by user plane entity 71 on behalf of the wireless communication network entity 74. The user plane entity 71 provides a response and/or output of the service to the session control entity 72.

At step S7-6 the session control entity 72 forwards the response and/or output of the service to the wireless communication network entity 74.

In the following specific embodiments relating to the method described with reference to FIG. 7 will be described in details. It will be understood that, as described in the following, not all steps illustrated in FIG. 7 are necessary for the implementation of every embodiment.

In particular, as illustrated for instance in FIG. 7a, an embodiment of the invention can relate to a method for operating a session control entity 72 in a wireless communication network, the wireless communication network comprising a user plane entity 71, the session control entity 72, a user repository entity 73, and a wireless communication network entity 74.

The session control entity 72 can be generally configured to handle at least one data packet session in the wireless communication network. The user plane entity 71 can be generally configured to handle a user plane of the at least one data packet session. The user repository entity 73 can be generally configured to register subscriber information for users of the wireless communication network. The wireless communication network entity 74 can be generally an entity of the wireless communication network accessing services of at least the user plane entity 71.

The method can comprise a step S7-3 of receiving from the wireless communication network entity 74 a service registration message comprising:
a service indication, for indicating a service provided by the user plane entity 71,
an identifier of a user of the wireless communication network.

In some embodiments, if the service needs parameters for its configuration and/or operation, those parameters can also be included in the service registration message.

The method can further comprise a step S7-4 of transmitting to the user plane entity 71 a subscription message, in response to the service registration message, for subscribing the wireless communication network entity 74 to the service indicated by the service indication.

Thanks to this approach it is possible to subscribe the wireless communication network entity 74 to the service through the session control entity 72.

In some embodiments. the method can further comprise a step S7-5 of receiving from the user plane entity 71 a first response message, in response to the subscription message.

Moreover the method can further comprise a step S7-6 of transmitting to the wireless communication network entity 74, a second response message, in response to the service registration message, comprising at least part of the content of the first response message.

In this manner it is possible to forward the output of the service to the wireless communication network entity 74.

Additionally, as illustrated for instance in FIG. 7b, an embodiment of the invention can relate to a method for operating a wireless communication network entity 74 in a wireless communication network, the wireless communication network comprising a user plane entity 71, a session control entity 72, a user repository entity 73, and the wireless communication network entity 74.

The session control entity 72 can be generally configured to handle at least one data packet session in the wireless communication network. The user plane entity 71 can be generally configured to handle a user plane of the at least one data packet session. The user repository entity 73 can be generally configured to register subscriber information for users of the wireless communication network. The wireless communication network entity 74 can be generally an entity of the wireless communication network accessing services of at least the user plane entity 71.

The method can comprise a step S7-1 of transmitting to the user repository entity 73 a session control discovery message, comprising:
an identifier of a user of the wireless communication network.

The method can further comprise a step S7-2 of receiving from the user repository entity 73 a session control indication message, in response to the session control discovery message, comprising:
the address of the session control entity 72.

Additionally, the method can further comprise a step S7-3 of transmitting to the session control entity 72 a service registration message comprising:
a service indication, for indicating a service provided by the user plane entity 71,
the identifier of the user of the wireless communication network.

In some embodiments. the method can further comprise a step S7-6 of receiving S7-6 from the session control entity 72, a response message, in response to the service registration message.

In some embodiments, specifically in an implementation of the embodiments described with reference to FIG. 7 in a 5G network, one or more of steps S7-1 to S7-7 could be formally formulated as:

S7-1: Nudm_Get SMF (User-ID)

S7-2: SMF address

S7-3: Nsmf_UPF Service Request/Subscribe (User-ID, service-ID, params)

S7-4: Nupf_Service Request/Subscribe

S7-5: Response

S7-6: Response

Although the methods above have each been described independently with reference to a Figure comprising a plurality of steps implemented by a plurality of nodes, it will be clear that the invention can be implemented by a subset of those steps, carried out by one or more nodes. Moreover, features and advantages of one step described for a given embodiment can also apply to the same step, and/or an analogous step, described for a different embodiment.

Moreover, although the description above has been discussed in terms of method steps, it will be clear that the invention can also be implemented by respective devices.

In particular, FIG. 8 shows an example schematic of a:
user plane entity 21,
session control entity 22,
network repository entity 23,
user plane entity 31,
session control entity 32,
network repository entity 33,
session control entity 44,
session control entity 52,
wireless communication network entity 54,
user repository entity 63,
session control entity 62,
wireless communication network entity 64,
session control entity 72,
wireless communication network entity 74,

each comprising a processing unit 81, an interface 82 and a memory 83. The interface 82 is configured to allow communication with other entities in the wireless communication network. The memory 83 can comprise instructions configured to cause the processing unit 81 to carry out any of steps described above with reference to the respective entity.

Moreover, the respective devices for implementing the invention can be also defined in terms of modules.

In particular, FIGS. 9-14 show example schematics of various modules of the:
user plane entity 21,
session control entity 22,
network repository entity 23,
user plane entity 31,
session control entity 32,
network repository entity 33,
session control entity 44,
session control entity 52,
wireless communication network entity 54,
user repository entity 63,
session control entity 62,
wireless communication network entity 64,
session control entity 72,
wireless communication network entity 74.

The modules generally allow each entity to implement any of the steps previously described in combination with the respective entity. More specifically, FIG. 9a schematically illustrates modules M2-3, M2-4 and M2-5, configured for carrying out the functionality of step S2-3, S2-4 and S2-5, respectively. FIG. 9b schematically illustrates modules M2-2, and M2-5, configured for carrying out the functionality of step S2-2 and S2-5, respectively. FIG. 9c schematically illustrates modules M2-2, M2-3 and M2-4, configured for carrying out the functionality of step S2-2, S2-3 and S2-4, respectively. FIG. 10a schematically illustrates modules M3-1, M3-4 and M3-5, configured for carrying out the functionality of step S3-1, S3-4 and S3-5, respectively. FIG. 10b schematically illustrates modules M3-2, M3-3 and M3-4, configured for carrying out the functionality of step S3-2, S3-3 and S3-4, respectively. FIG. 10c schematically illustrates modules M3-1, M3-2 and M3-3, configured for carrying out the functionality of step S3-1, S3-2 and S3-3, respectively. FIG. 11a schematically illustrates modules M4-3, M4-5 and M4-6, configured for carrying out the functionality of step S4-3, S4-5 and S4-6, respectively. FIG. 12a schematically illustrates modules M5-3 and M5-4, configured for carrying out the functionality of step S5-3 and S5-4, respectively. FIG. 12b schematically illustrates modules M5-3 and M5-4, configured for carrying out the functionality of step S5-3 and S5-4, respectively. FIG. 13a schematically illustrates modules M6-2, M6-4 and M6-5, configured for carrying out the functionality of step S6-2, S6-4 and S6-5, respectively. FIG. 13b schematically illustrates modules M6-1 and M6-2, configured for carrying out the functionality of step S6-1 and S6-2, respectively. FIG. 13b schematically illustrates modules M6-4 and M6-5, configured for carrying out the functionality of step S6-4 and S6-5, respectively. FIG. 14a schematically illustrates modules M7-3 and M7-4, configured for carrying out the functionality of step S7-3 and S7-4, respectively. FIG. 14b schematically illustrates modules M7-1, M7-2 and M7-3, configured for carrying out the functionality of step S7-1, S7-2 and S7-3, respectively.

It will be clear that any of those entities can further comprise a module implementation of the other steps previously described.

In particular, in some embodiments, the session control entity 22 can further comprise modules M2-6 and M2-7, configured for carrying out the functionality of step S2-6 and S2-7, respectively, as illustrated in dashed lines in FIG. 15 to indicate that those modules are optional the session control entity 22.

Moreover, in some embodiments, the network repository entity 23 can further comprise modules M2-6 and M2-7, configured for carrying out the functionality of step S2-6 and S2-7, respectively, as illustrated in dashed lines in FIG. 16 to indicate that those modules are optional the network repository entity 23.

Moreover, in some embodiments, the session control entity 32 can further comprise one or more of modules M3-5, M3-6 and M3-7, configured for carrying out the functionality of step S3-5, S3-6 and S3-7, respectively, as illustrated in dashed lines in FIG. 17 to indicate that those modules are optional the session control entity 32.

Moreover, in some embodiments, the network repository entity 33 can further comprise modules M3-6 and M3-7, configured for carrying out the functionality of step S3-6 and S3-7, respectively, as illustrated in dashed lines in FIG. 18 to indicate that those modules are optional the network repository entity 33.

Moreover, in some embodiments, the session control entity 44 can further comprise one or more of modules M4-8 to M4-10, configured for carrying out the functionality of step S4-8 to S4-10, respectively, as illustrated in dashed lines in FIG. 19 to indicate that those modules are optional the session control entity 44.

Moreover, in some embodiments, the wireless communication network entity 54 can further comprise module M5-5 configured for carrying out the functionality of step M5-5, as illustrated in dashed lines in FIG. 20 to indicate that those modules are optional the wireless communication network entity 54.

Moreover, in some embodiments, the session control repository entity 72 can further comprise modules M7-5 and M7-6, configured for carrying out the functionality of step S7-5 and S7-6, respectively, as illustrated in dashed lines in FIG. 21 to indicate that those modules are optional the session control repository entity 72.

Moreover, in some embodiments, the wireless communication network entity 74 can further comprise module M7-6 configured for carrying out the functionality of step S7-6, as illustrated in dashed lines in FIG. 22 to indicate that this modules is optional the wireless communication network entity 74.

It will be further clear that any of those entities can further comprise additional module implementations, not illustrated, of the other steps previously described.

From the above said some general conclusions can be drawn: in general, the invention allows implementing a service-based user plane entity in a wireless communication network. Specific embodiments have been discussed regarding specific aspects of the implementation of the service-based user plane entity, such as how to associate the service-based user plane entity to other entities in the network, how to initiate a packet session, how to identify and/or subscribe to services offered by the service-based user plane entity.

### REFERENCE NUMERALS

100: 5G core network
101: Network Slice Selection Function
102: Network Exposure Function
103: Network Repository Function
104: Policy Control Function
105: Unified Data Management
106: Application Function
107: Authentication Server Function
108: Access and Mobility Management Function
109: Session Management Function
110: User Equipment
111: Radio Access Network
112: User Plane Function
113: Data Network
114: Network Data Analytics Function
21: user plane entity
22: session control entity
23: network repository entity
S2-1: sending/receiving registration message
S2-2: sending/receiving registration message
S2-3: sending/receiving discovery message
S2-4: sending/receiving response message
S2-5: sending/receiving association request message
S2-6: sending/receiving capabilities request message
S2-7: sending/receiving capabilities indication message
S2-8: sending/receiving association confirmation message
31: user plane entity
32: session control entity
33: network repository entity
S3-1: sending/receiving registration message
S3-2: sending/receiving discovery message
S3-3: sending/receiving response message
S3-4: sending/receiving association request message
S3-5: sending/receiving association confirmation message
S3-6: sending/receiving capabilities request message
S3-7: sending/receiving capabilities indication message
41: mobility management entity
42: user plane entity
43: user plane entity
44: session control entity
45: policy control entity
46: network repository entity
S4-1: sending/receiving session establishment request message
S4-2: sending/receiving policy request message
S4-3: sending/receiving policy activation message
S4-4: evaluating traffic breakout
S4-5: sending/receiving discovery message
S4-6: sending/receiving response message
S4-7: selecting user plane entity
S4-8: sending/receiving service configuration message
S4-9: sending/receiving service configuration message
S4-10: sending/receiving session establishment message
S4-11: sending/receiving session establishment message
S4-12: sending/receiving response message
S4-13: sending/receiving response message
S4-14: completing session establishment
51: user plane entity
52: session control entity
53: user repository entity
54: wireless communication network entity
S5-1: sending/receiving session control discovery message
S5-2: sending/receiving response message
S5-3: sending/receiving service discovery message
S5-4: sending/receiving response message
S5-5: sending/receiving service request message
S5-6: sending/receiving response message
61: user plane entity
62: session control entity
63: user repository entity
64: wireless communication network entity
S6-1: selecting service
S6-2: sending/receiving service registration message
S6-3: sending/receiving response message
S6-4: sending/receiving service discovery message
S6-5: sending/receiving response message
S6-6: sending/receiving service request message
S6-7: sending/receiving response message
71: user plane entity
72: session control entity
73: user repository entity
74: wireless communication network entity
S7-1: sending/receiving session control discovery message
S7-2: sending/receiving response message
S7-3: sending/receiving service registration message
S7-4: sending/receiving subscription message
S7-5: sending/receiving response message
S7-7: sending/receiving response message
81: processing unit
82: interface
83: memory

1.-93. (canceled)

94. A method for operating a user plane entity in a wireless communication network, the wireless communication network comprising the user plane entity, a plurality of session control entities and a network repository entity,
the plurality of session control entities being configured to handle at least one data packet session in the wireless communication network,
the user plane entity being configured to handle a user plane of the at least one data packet session,
the network repository entity being configured to register the plurality of session control entities and the user plane entity,
the method comprising the steps of:
transmitting to the network repository entity a discovery message comprising:
an association request indication, for indicating that the user plane entity can be associated to a session control entity,
filtering criteria for filtering the plurality of session control entities,
receiving from the network repository entity a response message, in response to the discovery message, comprising:
a list of filtered session control entities, filtered based on the filtering criteria, transmitting to a first filtered session control entity, of the filtered session control entities,
an association request message comprising:
an identifier of the user plane entity.

95. The method of claim 94, wherein the association request message further comprises a list of capabilities of the user plane entity.

96. A user plane entity for a wireless communication network, the wireless communication network comprising the user plane entity, a plurality of session control entities and a network repository entity,
the plurality of session control entities being configured to handle at least one data packet session in the wireless communication network,
the user plane entity being configured to handle a user plane of the at least one data packet session,
the network repository entity being configured to register the plurality of session control entities and the user plane entity,
the user plane entity comprising a processing unit and a memory, the memory comprising instructions configured to cause the processing unit to carry out the steps of claim 94.

97. The user plane entity of claim 96, wherein the association request message further comprises a list of capabilities of the user plane entity.

98. A method for operating a network repository entity in a wireless communication network, the wireless communication network comprising a user plane entity, a plurality of session control entities and the network repository entity,
the plurality of session control entities being configured to handle at least one data packet session in the wireless communication network,
the user plane entity being configured to handle a user plane of the at least one data packet session,
the network repository entity being configured to register the plurality of session control entities and the user plane entity,
the method comprising the steps of:
receiving, from at least one of the plurality of session control entities, a registration message comprising:
an association service indication, for indicating that the at least one session control entity can be associated to a user plane entity,
an area indication of the at least one session control entity,
receiving from the user plane entity a discovery message comprising:
an association request indication, indicating that the user plane entity can be associated to a session control entities,
filtering criteria for filtering the plurality of session control entities,
transmitting to the user plane entity a response message, in response to the discovery message, comprising:
a list of filtered session control entities, filtered based on the filtering criteria.

99. The method of claim 98, further comprising the steps of:
receiving from the at least one session control entity a capabilities request message comprising:
an identifier of the user plane entity,
transmitting to the at least one session control entity a capabilities indication message, in response to the capabilities request message, comprising:
a list of capabilities of the user plane entity identified by the identifier.

100. A network repository entity for a wireless communication network, the wireless communication network comprising a user plane entity, a plurality of session control entities and the network repository entity,
the plurality of session control entities being configured to handle at least one data packet session in the wireless communication network,
the user plane entity being configured to handle a user plane of the at least one data packet session,
the network repository entity being configured to register the plurality of session control entities and the user plane entity,
the network repository entity comprising a processing unit and a memory, the memory comprising instructions configured to cause the processing unit to carry out the steps of claim 98.

101. The network repository entity of claim 100, the memory further comprising instructions configured to cause the processing unit to carry out the steps of:
receiving from the at least one session control entity a capabilities request message comprising:
an identifier of the user plane entity,
transmitting to the at least one session control entity a capabilities indication message, in response to the capabilities request message, comprising:
a list of capabilities of the user plane entity identified by the identifier.

102. A method for operating a session control entity in a wireless communication network, the wireless communication network comprising a plurality of user plane entities, the session control entity, a policy control entity, and a network repository entity,
the session control entity being configured to handle at least one data packet session in the wireless communication network,
the plurality of user plane entities being configured to handle a user plane of the at least one data packet session,
the policy control entity being configured to handle a policy plane of the at least one data packet session,
the network repository entity being configured to register the plurality of session control entities and the user plane entity,
the method comprising the steps of:
receiving from the policy control entity a policy activation message comprising:
a list of services to be activated in the plurality of user plane entities,
transmitting to the network repository entity a discovery message comprising:
filtering criteria for filtering the plurality of user plane entities,
receiving from the network repository entity a response message, in response to the discovery message, comprising:
a list of filtered user plane entities, filtered based on the filtering criteria.

103. The method of claim 102, wherein the filtering criteria comprise:
the list of services to be activated in the plurality of user plane entities.

104. The method of claim 102, further comprising the step of:
transmitting to one of the filtered user plane entities a service configuration message for activating and/or configuring at least one of the list of services to be activated.

105. The method of claim 102, further comprising the step of:
transmitting to one of the filtered user plane entities a session establishment message for configuring one of the list of services to be activated.

106. A session control entity for a wireless communication network, the wireless communication network comprising a plurality of user plane entities, the session control entity, a policy control entity, and a network repository entity,
the session control entity being configured to handle at least one data packet session in the wireless communication network,
the plurality of user plane entities being configured to handle a user plane of the at least one data packet session,
the policy control entity being configured to handle a policy plane of the at least one data packet session,
the network repository entity being configured to register the plurality of session control entities and the user plane entity,
the session control entity comprising a processing unit and a memory, the memory comprising instructions configured to cause the processing unit to carry out the steps of claim 102.

107. The session control entity of claim 106, wherein the filtering criteria comprise:
the list of services to be activated in the plurality of user plane entities.

108. The session control entity of claim 106, further comprising the step of:
transmitting to one of the filtered user plane entities a service configuration message for activating and/or configuring at least one of the list of services to be activated.

109. The session control entity of claim 106, further comprising the step of:
transmitting to one of the filtered user plane entities a session establishment message for configuring one of the list of services to be activated.

110. A method for operating a wireless communication network entity in a wireless communication network, the wireless communication network comprising a user plane entity, a session control entity, a user repository entity, and the wireless communication network entity,
the session control entity being configured to handle at least one data packet session in the wireless communication network,
the user plane entity being configured to handle a user plane of the at least one data packet session,
the user repository entity being configured to register subscriber information for users of the wireless communication network,
the wireless communication network entity being an entity of the wireless communication network accessing services of at least the user plane entity,
the method comprising the steps of:
transmitting to the session control entity a service discovery message comprising:
a service indication, for indicating a service provided by the user plane entity,
an identifier of a user of the wireless communication network,
receiving from the session control entity a response message, in response to the service discovery message, comprising:
an address of the user plane entity.

111. The method of claim 110, further comprising the steps of:
transmitting to the user plane entity a service request message comprising:
the service indication,
the identifier of the user of the wireless communication network.

112. A wireless communication network entity for a wireless communication network, the wireless communication network comprising a user plane entity, a session control entity, a user repository entity, and the wireless communication network entity,
the session control entity being configured to handle at least one data packet session in the wireless communication network,
the user plane entity being configured to handle a user plane of the at least one data packet session,
the user repository entity being configured to register subscriber information for users of the wireless communication network,
the wireless communication network entity being an entity of the wireless communication network accessing services of at least the user plane entity, the wireless communication network entity comprising a processing unit and a memory, the memory comprising instructions configured to cause the processing unit to carry out the steps of claim 110.

113. The wireless communication network entity of claim 112, the memory further comprising instructions configured to cause the processing unit to carry out the steps of:
transmitting to the user plane entity a service request message comprising:
the service indication,
the identifier of the user of the wireless communication network.
